(19) United States
(12) Patent Application Publication
(10) Pub. No.: US 2023/0373008 A1
(43) Pub. Date: Nov. 23, 2023

(54) METHOD AND PYRIFORM PROCESS METRIC TO PREDICT AND MITIGATE SPATTER- INDUCED DEFECTS IN POWDER BED FUSION-LASER BEAM METALS ADDITIVE MANUFACTURING

(71) Applicant: United States of America as represented by the Administrator of NASA, Washington, DC (US)

(72) Inventors: John-Andrew Samuel Hocker, Newport News, VA (US); Brodan M. Richter, St. Paul, MN (US)

(21) Appl. No.: 18/224,935

(22) Filed: Jul. 21, 2023

Related U.S. Application Data
(63) Continuation-in-part of application No. 18/143,719, filed on May 5, 2023.
(60) Provisional application No. 63/339,149, filed on May 6, 2022.
(60) Provisional application No. 63/398,711, filed on Aug. 17, 2022.

(51) Int. Cl. B22F 10/80; B33Y 50/00

(52) U.S. Cl. CPC B22F 10/80; B33Y 50/00; G06N 20/10

(57) ABSTRACT

The present disclosure presents various additive manufacturing systems and methods. One such method comprises obtaining a build file containing instructions to additively manufacture a component; generating at least one point field; computing a spatter exposure metric from the at least one point field to quantify a risk of spatter induced porosity throughout a build; and updating the at least one point field with the spatter exposure metric computed. Computing the spatter exposure metric may include selecting at least one principal point from the at least one point field; determining at least one neighborhood using an additive manufacturing model search algorithm for the at least one principal point; and integrating a pyriform kernel function for the at least one principal point and the at least one neighborhood. Other systems and methods are also disclosed.

### CROSS-REFERENCE TO RELATED APPLICATION

This application is a continuation-in-part of co-pending U.S. Utility Patent Application entitled, Method of Generating a Model for Additive Manufacturing,” having serial application Ser. No. 18/143,719, filed on May 5, 2023, which claims the benefit and priority to U.S. Provisional Patent Application No. 63/339,149, filed on May 6, 2022, and U.S. Provisional Patent Application No. 63/398,711, filed on Aug. 17, 2022, the contents each of which are incorporated herein by reference in their entireties.

### STATEMENT REGARDING FEDERALLY SPONSORED RESEARCH OR DEVELOPMENT

The disclosure described herein was made by employees of the United States Government and may be manufactured and used by or for the Government of the United States of America for governmental purposes without the payment of any royalties thereon or therefor.

### TECHNICAL FIELD

The present disclosure relates generally to powder bed fusion technology. More specifically, the present disclosure relates to a method of controlling spatter during powder bed fusion-laser beam metals additive manufacturing to thereby reduce fusion porosity in produced layers and welds.

### BACKGROUND

Powder bed fusion-laser beam metals (L-PBF or PBF-LB/M) additive manufacturing (AM) can produce components in a cost-effective manner. In some aerospace applications, it is the most economic approach to manufacturing a component.

Laser powder bed fusion (PBF-LB/M) is a specific type of AM that uses a powder feedstock that is spread upon a flat substrate and fused by a laser heat source. The fusion process requires both the feedstock and the immediately adjacent substrate to melt. The short duration, translating melt created by the scanning laser is referred to as a melt pool, which comprises a weld. Melt pool control governs the quality of the weld and, thus, the quality of the part created by the PBF-LB/M AM process.

The PBF-LB/M AM components are built up through a multitude of layers and welds, also referred to as melt pools. The welds are a result of a laser spot melting material sequentially and according to a predefined pattern.

The PBF-LB/M AM process is the result of a build strategy applied to parts oriented in the build envelope. A build strategy is comprised of laser powers, foci, and velocities orchestrated in hatch patterns and spacings such that the fusion of feedstock is overlapped to consolidate fully dense additively manufactured parts. When general build strategies are applied to a part, unexpected process conditions can result in underheating or overheating that lead to inconsistent fusion. Hatch pattern, laser power, velocity, and layer thickness are among the primary settings that comprise a build strategy. Each build strategy decision contributes to the overall build quality. AM process design engineers typically develop generalized build strategies that rely on heuristic rules and guidelines to design successful builds. The need for generalized build strategies is due to the broad time and length scales associated with the PBF-LB/M process compared to the melt events.

Spattering can occur during welding as a part of the PBF-LB/M process. Welding spatter can attenuate the intensity of the laser beam reaching the surface weld via light scattering, absorption, and reflections. A crossflow gas is typically used to push the spatter away from the laser beam so that the expected laser intensity reaches the weld at the surface during the PBF-LB/M AM process.

The crossflow gas velocity is consistent along the axis of the PBF-LB/M process and is most often perpendicular to the spreader axis. The crossflow blows the spatter directionally along its axis, from the gas outlet to the gas inlet.

Large ejecta, molten droplets with a diameter greater than about 75 μm, are produced as spatter during the PBF-LB/M welding process. Additionally, such large ejecta can land on the surface of the build plane. When the large ejecta land and are subsequently welded to the surface, they effectively cause the local layer thickness to be greater than the PBF-LB/M process was designed to consolidate. The significantly thicker local layer of material may not be fully melted and consolidated with the previous layer as a result. A lack of fusion defect during PBF-LB/M occurs when material is unable to be consolidated. When a spatter ejecta welds to the surface it can cause a lack of fusion defect or porosity by shielding the surface below from being consolidated with the subsequent layers. Porosity can induce crack-growth mechanisms and thereby reduce service life of components via structural failure.

### SUMMARY OF THE PRESENT INVENTION

The present invention is directed to controlling or predicting the occurrence of spatter induced porosity using a hatch progression angle or a pyriform density function process metric, relative to crossflow.

One embodiment of the present invention is a method comprising obtaining a build file containing instructions to additively manufacture a component; generating at least one point field; computing a spatter exposure metric from at least one point field to quantify a risk of spatter induced porosity throughout a build; and updating the at least one point field with the spatter exposure metric computed, wherein computing the spatter exposure metric includes selecting at least one principal point from the at least one point field; determining at least one neighborhood using an additive manufacturing model search algorithm for the at least one principal point; integrating a pyriform kernel function for the at least one principal point and the at least one neighborhood to obtain the spatter exposure metric; and updating at least one point field with the spatter exposure metric computed.

For another embodiment of the present invention, such a method further comprises determining if the build file should be modified based on the spatter exposure metric.

For another embodiment of the present invention, such a method further comprises modifying the build file for the component based on the spatter exposure metric if it is determined that the build file should be modified.

For another embodiment of the present invention, integrating at least one additive manufacturing model kernel function for the at least one principal point is based on a single point in time for the at least one principal point.

For another embodiment of the present invention, generating the at least one point field for the component includes generating a model-based point field from the build file or generating at least one measure-based point field from in-situ measured data.

For another embodiment of the present invention, integrating the pyriform kernel function comprises fitting a pyriform shape to spatter conditions of a specific build material, crossflow characteristics, or processing parameters.

For another embodiment of the present invention, such a method further comprises controlling an occurrence of spatter induced porosity in the build using the computed spatter exposure metric.

For another embodiment of the present disclosure, such a method further comprises designing a build strategy to minimize spatter based on the computed spatter exposure metric which includes a modification of the build plane to be below a set focal plane by a distance that is characteristic of the spatter size.

For another embodiment of the present disclosure, such a method further comprises printing a component using the designed build strategy.

Yet another embodiment of the present invention is a method of additive manufacturing, comprising setting a build's coordinate reference axis to be that of a crossflow reference axis, where the crossflow axis is colinear with the y-axis of the build coordinates; designing a build file that mitigates spatter induced porosity by enforcing a hatch progression angle during the build with a trigonometric function that is based on the build's reference axis and the crossflow reference axis; and printing a component using the build file.

For another embodiment of the present invention, the trigonometric function comprises a cosine function.

For another embodiment of the present invention, a value of the cosine function of the hatch progression angle is enforced to be between −1 and 0, where the crossflow axis is colinear with a y-axis of the build coordinates and the hatch progression proceeds predominantly opposite the crossflow direction.

Yet another embodiment of the present invention is a non-transitory computer-readable storage medium embodying programmed instructions which, when executed by a processor, are operable for performing operations comprising obtaining a build file containing instructions to additively manufacture a component; generating at least one point field; computing a spatter exposure metric from the at least one point field to predict a risk of spatter induced porosity throughout a build; and updating the at least one point field with the spatter exposure metric computed, wherein computing the spatter exposure metric includes selecting at least one principal point from the at least one point field; determining at least one neighborhood using an additive manufacturing model search algorithm for the at least one principal point; and integrating a pyriform kernel function for the at least one principal point and the at least one neighborhood to obtain the spatter exposure metric.

For another embodiment of the present invention, such operations further comprise determining if the build file should be modified based on the spatter exposure metric.

For another embodiment of the present invention, such operations further comprise modifying the build file for the component based on the spatter exposure metric if it is determined that the build file should be modified.

For another embodiment of the present invention, generating the at least one point field for the component includes generating a model-based point field from the build file or generating at least one measure-based point field from in-situ measured data.

For another embodiment of the present invention, integrating the pyriform kernel function comprises fitting a pyriform shape to spatter conditions of a specific build material, crossflow characteristics, or processing parameters.

For another embodiment of the present invention, such operations further comprise controlling an occurrence of spatter induced porosity in the build using the computed spatter exposure metric.

For another embodiment of the present disclosure, such operations further comprise designing a build strategy to minimize spatter based on the computed spatter exposure metric which includes a modification of the build plane to be below a set focal plane by a distance that is characteristic of the spatter size.

For another embodiment of the present disclosure, such operations further comprise printing a component using the designed build strategy.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an example additive manufacturing system in accordance with various embodiments of the present disclosure.

FIG. 2 illustrates an example point field with a principal point located in a neighborhood.

FIG. 3 illustrates an example method of generating process metrics from at least one point field in accordance with various embodiments of the present disclosure.

FIGS. 4(a)-(c) present illustrations of spatter characteristics (a) being influenced by the crossflow direction during the PBF-LB/M process, (b) pyriform density field describing stochastic surface impacts, and (c) a post-exposure layer intensity color-mapped photograph with the spatter ejecta surface impact field and exposed surface indicated.

FIGS. 5(a)-5(f) show photographic images of six additive manufacturing specimens that were studied in accordance with the present disclosure.

FIGS. 6(a)-6(f) show a series of summary plots for specimen P1-A of FIG. 5(a).

FIGS. 7(a)-7(f) show a series of summary plots for specimen P1-B of FIG. 5(b).

FIGS. 8(a)-8(f) show a series of summary plots for specimen P1-C of FIG. 5(c).

FIGS. 9(a)-9(f) show a series of summary plots for specimen P2-A of FIG. 5(d).

FIGS. 10(a)-10(f) show a series of summary plots for specimen P2-B of FIG. 5(e).

FIGS. 11(a)-11(f) show a series of summary plots for specimen P2-C of FIG. 5(f).

FIGS. 12(a)-12(b) graphically depict a total pore count for each specimen for the (a) P1 parameter set and (b) P2 parameter set.

### DETAILED DESCRIPTION

The following description is merely exemplary in nature and is not intended to limit the present disclosure, application, or uses. It should be understood that throughout the drawings, corresponding reference numerals indicate like or corresponding parts and features.

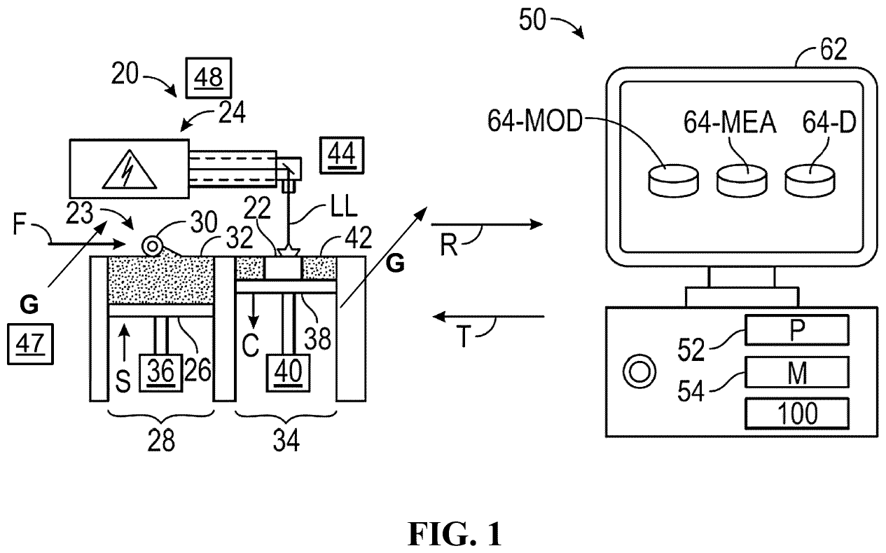

For purposes of description herein, the terms “upper,” “lower,” “right,” “left,” “rear,” “front,” “vertical,” “horizontal,” and derivatives thereof shall relate to orientation shown in FIG. 1. However, it is to be understood that various alternative orientations and step sequences may be envisioned, except where expressly specified to the contrary. Also, for purposes of the present detailed description, words of approximation such as “about,” “almost,” “substantially,” “approximately,” and the like, may be used herein in the sense of “at, near, or nearly at,” or “within 3-5% of,” or “within acceptable manufacturing tolerances,” or any logical combination thereof. It is also to be understood that the specific devices and processes illustrated in the attached drawings, and described in the following specification, are exemplary embodiments of the inventive concepts defined in the appended claims. Hence, specific dimensions and other physical characteristics relating to the embodiments disclosed herein are not to be considered as limiting, unless the claims expressly state otherwise.

Before the present disclosure is described in further detail, it is to be understood that the disclosure is not limited to the particular embodiments described, and as such may, of course, vary. It is also to be understood that the terminology used herein is for the purpose of describing particular embodiments only, and is not intended to be limiting, since the scope of the present disclosure will be limited only by the appended claims.

A number of materials are identified as suitable for various aspects of the present disclosure. These materials are to be treated as exemplary and are not intended to limit the scope of the claims. Although any methods and materials similar or equivalent to those described herein can also be used in the practice or testing of the present disclosure, a limited number of exemplary methods and materials are described herein.

It must be noted that as used herein and in the appended claims, the singular forms “a,” “an,” and “the” include plural referents unless the context clearly dictates otherwise.

In general, the meaning of the various terms and abbreviations as used herein is as they are generally used and accepted in the art, unless otherwise specified. In order to aid in the understanding of the invention, specific meanings of several terms are provided.

Referring to the drawings, wherein like reference numbers refer to like features throughout the several views, FIG. 1 schematically depicts an exemplary additive manufacturing system 20 and a computer system 50 for controlling the additive manufacturing process. The computer system 50 is configured as set forth herein to execute an instruction set T embodying a build file to build a component 22 on the additive manufacturing system 20. The component 22 can be made of aluminum, stainless steel, titanium, metal alloy, or additive manufacturable material in a non-limiting implementation of the present teachings. Furthermore, the computer system 50 can receive information R from in-situ sensors 44 including but not limited to sensors that record the time resolved mirror positions and laser powers for the additive manufacturing system 20 and store the information in a non-transitory computer-readable storage medium (M) 54 in the computer system 50.

The component 22 contemplated herein can in one or more embodiments be constructed via the additive manufacturing process. As will be appreciated by those of ordinary skill in the art, metal-based additive manufacturing or “3D printing” can entail the use of a powder bed fusion process 23 and a concentrated heat source 24, such as but not limited to an electron or laser formation beam LL as shown. Use of the beam LL progressively melts metal powder stock 42 and thereby builds the metal test component 22 in an accumulative or progressive/layer-by-layer manner. The powder bed fusion process 23 shown in FIG. 1 may position a volume of the metal powder stock 32 on a moveable supply platform 26 within a powder feed chamber 28, with a leveling roller 30 possibly translating across the powder feed chamber 28 in the direction of arrow F. This motion enables the leveling roller 30 to displace a thin layer of the metal powder stock 32 toward an adjacent build chamber 34 as the supply platform 26 rises in the direction of arrow S, e.g., using a hydraulic or pneumatic piston 36.

While the illustrated example utilizes the leveling roller 30, other mechanisms, such as a doctor blade, could be used to displace the metal powder stock 32. Furthermore, this disclosure is not limited to additive manufacturing systems 20 L-PBF or PBF-LB/M but applies to additive manufacturing that approaches control position and heat intensity such as when utilizing an electron-beam source (power feedback is in electron V/Amps and spot delivery is controlled using magnetic fields) or a fused element deposition additive approach (e.g., heat intensity is controlled through a heated nozzle is controlled through a motorized linear motion “table-top gantry”).

Once the leveling roller 30 has deposited some of the metal powder stock 32 onto a moveable build platform 38 or a previously formed layer of the test component 22, the heat source 24 directs the beam LL onto the deposited metal powder stock 32 according to a predetermined pattern, to thereby construct a layer of the component 22. In various embodiments, a flow of gas G is provided from a gas outlet grill 47 to a gas inlet grill 48 to push spatter away from the laser beam so that the expected laser intensity reaches the weld at the surface, during the PBF-LB/M AM process. The crossflow gas velocity is consistent along the axis of the PBF-LB/M process and is most often perpendicular to the spreader axis. The crossflow G blows the spatter directionally along its axis, from the gas outlet grill to the gas inlet grill.

In one example, the predetermined pattern is determined by a build file stored in the computer-readable storage medium (M) 54 and executed by a micro-processor (P) 52 on the computer system 50. The build platform 38 is then lowered in the direction of arrow C using a piston 40 or another suitable mechanism to enable another layer of the metal test component 22 to be formed. The piston 40 is analogous to the piston 36 but is actuated in the opposite direction. The process repeats until the component 22 has been fully printed, at which point residual powder stock 42 is carefully removed, e.g., via vibration, rinsing, suction, etc.

While the computer system 50 of FIG. 1 is depicted as a unitary computer module for illustrative simplicity, the computer system 50 can be physically embodied as one or more processing nodes having the computer-readable storage medium (M) 54, i.e., application-sufficient memory, and associated hardware and software, such as but not limited to a high-speed clock, timer, input/output circuitry, buffer circuitry, and the like. The computer-readable storage medium 54 may include enough read only memory, for instance magnetic or optical memory. Computer-readable code or instructions embodying a method 100 described below may be executed during operation of the computer system 50. To that end, the computer system 50 may encompass one or more processors (P) 52, e.g., logic circuits, application-specific integrated circuits (ASICs), central processing units, microprocessors, and/or other requisite hardware as needed to provide the programmed functionality described herein. A display screen 62 may be connected to or in communication with the computer-readable storage medium 54 and processor(s) 52 to facilitate intuitive graphical presentation of the results of a method 100 as set forth below.

One aspect of the present disclosure is directed to a method for creating a computationally efficient approach for assessing the additive manufacturing process at a part scale level with fusion level precision (i.e., weld tracks and patterns are taken into account) using additive manufacturing models. The method utilizes data from a build file for the part or component 22 stored in the computer-readable storage medium 54 on the computer system 50 or data collected from the in-situ sensors 44 during the additive manufacturing system 20 about the component 22. The build file contains sufficient information, such as build path and heat source intensities, to build the component 22 with the additive manufacturing system 20. The additive manufacturing models can be created from either of these data sets by utilizing a point field driven approach to additive manufacturing modeling to compute process metrics (PM) for the point field describing the component 22. This approach provides a methodology to compute the expected and observed fusion resolved process conditions throughout the additive manufacturing build process. In this disclosure, the method 100 includes a point field driven non-constant kernel convolution calculation.

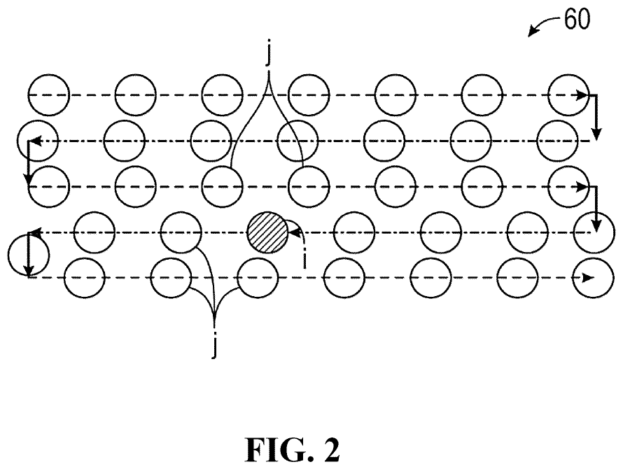

As will be described in greater detail below, the method 100 comprises point-wise analytical additive manufacturing model defined kernel functions to generate PMs and a model search algorithm to calculate measures of the physical state at each point in a point field (PF) 60 (FIG. 2). The PMs provide instantaneous single point-in-time data used for part-scale assessment of the additive manufacturing build integrity or for design improvements to the component 22 through modifying the build file on the computer system 50 for the component 22. The method 100 disclosed herein improves computational speed and precision when compared with other additive manufacturing modeling approaches. The PM approach to additive manufacturing allows for multiple analytical additive manufacturing models to be calculated directly from the point field 60 in a single pass and requires only material property inputs. As a result, calculations of the PMs have a favorable computational speed and operational simplicity for quantifying melt track resolved process conditions from the point field data. For example, the PMs for a point field in this disclosure can be calculated in a number of minutes compared to hours or days for a time-stepped model, such as finite element calculations of thermal rise. These calculations enable efficient prediction, assessment, and adjustment of additive manufacturing builds for reducing defects and developing statistical process controls.

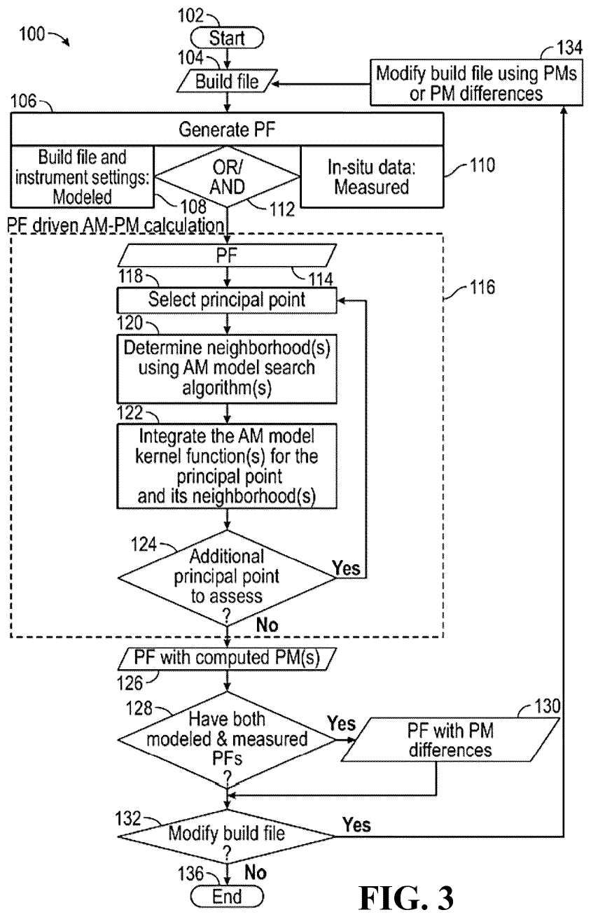

FIG. 3 illustrates the example method 100 of generating at least one point field that include computed PMs for each point in the point field. In one example, the method 100 is implemented on the computer system 50 discussed above. The method 100 initiates a start at Block 102. From the start at Block 102, the method 100 obtains a build file at Block 104 for evaluating the additive manufacturing process for the component 22.

The method 100 then generates at least one point field 60 describing the component 22 as shown in FIG. 2. The point field 60 generated as part of the method 100 (Block 106) is a collection of points having time resolved spatial coordinates and any additional information required to describe an additive manufacturing build, such as the laser spot size and power for PBF-LB/M additive manufacturing. In one example, the point field 60 is generated from the build file for the component 22 to create a model-based point field. (Block 108). In another example, a measured-based point field is generated from the in-situ sensors 44 that record the time resolved mirror positions and laser powers plus any additional information required to describe the additive manufacturing build for the additive manufacturing system 20. (Block 110). In particular, as discussed above, this disclosure applies to other additive manufacturing approaches that may not include mirrors or lasers.

As shown at Block 112, the method 100 can utilize at least one of the model-based point field generated from the build file at Block 108 or the measure-based point field generated from the in-situ measured data for the component 22 at Block 110. Also, the method 100 can utilize a series of builds of the same component 22 to generate multiple corresponding in-situ measured data sets to create a series of measure-based point fields. One feature of analyzing multiple measure-based point fields is to obtain an expected set of value for the points in the point field over series of components 22 built from the same build file. Also, analyzing multiple measure-based point fields for the series of components 22 can indicate if the additive manufacturing system 20 is in need of service or repair by identifying variations in the measure-based point fields and in the computer PMs for the point fields as will be discussed in greater detail below. Another feature of the method 100 is to evaluate the integrity of the build file.

Once the appropriate number of point fields are generated based on at least one of the build file or the in-situ measured data, the method 100 can begin performing PM calculations on the point fields (Block 114) through a process enclosed by Block 116.

Each of the PM calculations is the convolution of a non-constant kernel function, fᵢⱼ, with the neighborhood of the principal point, Øᵢⱼ as shown in Equation (1) below. A PMᵢ is the calculated PM value at each principal point i, such as the solid circle illustrated in FIG. 2. The chosen kernel function and model search algorithm are defined by the physical model of the additive manufacturing process that is being considered for each principal point in the point field 60.

PMᵢ=Σⱼ^{N} fᵢⱼØᵢⱼ (1)

Each of the point fields from Block 114 are evaluated in terms of a principal point, i, and its neighbors, j, as shown in FIG. 2, with the specific neighbors j being identified by the model search algorithm. The time resolved sequence of the point field points define the laser spot (heat source) movements along the dashed lines, while the laser power levels define whether the movement is a fusion or weld, power on, or a jump, power off. The angles of neighboring meandering hatches of fusions or welds have a difference of π radians. In Block 118, the method 100 selects a principal point i from the entire point field 60 and then determines at least one neighborhood from and/or including neighbors j from at least one additive manufacturing model search algorithm at Block 120. The model search algorithm will determine the neighbors j that form a neighborhood of points to include in the calculations.

The neighborhood is determined for each principal point i by the model search algorithm, or function set, Øᵢⱼ. In one example, a Heaviside function can be used such that 1 is returned when the spatial and temporal conditions are satisfied and 0 otherwise as shown in Equation (2) below. The model search algorithm may include spatial conditions such that the distance, rᵢⱼ, is less than or equal to a variable neighborhood distance, Rᵢ.

$${∅}_{ij} = \{ \begin{matrix}1 & if {r}_{ij} \leq {R}_{i} \& {τ}_{ij} \geq {t}_{i}^{delay} \\ 0 & else\end{matrix} \qquad ( 2 )$$

The distance, rᵢⱼ, between the principal i and the neighborhood point j is calculated using the three-dimensional (3D) cartesian coordinate distance, as shown in Equation (3) below. By setting Rᵢ to a constant value C in Equation (4), a non-variable PM neighborhood distance, Rᵢ^{C}, can be taken as a neighborhood radius. Alternatively, Rᵢ in Equation (4) below could be functional driven and not always a constant “C.” The coordinate distances on the x, y and z axes are calculated between the principal point i and the neighborhood point j using Equations (5-7) below.

rᵢⱼ=\sqrt{dxᵢⱼ²+dyᵢⱼ²+dzᵢⱼ²} (3)

Rᵢ^{C}=C (4)

dxᵢⱼ=xᵢ−xⱼ (5)

dyᵢⱼ=yᵢ−yⱼ (6)

dzᵢⱼ=zᵢ−zⱼ (7)

In one example for calculating PMs in this disclosure, time can be recorded in the point field with a resolution that is equal to or better than the characteristic timescale of the process. In particular, a time scale for a digital galvanometer used in PBF-LB/M additive manufacturing instruments could be 10 μs. The time component of the neighborhood search algorithm is defined as the difference in time, τᵢⱼ, being greater than or equal to a variable time delay, tᵢ^{delay}. Relative to the principal point, i, the neighborhood may be composed of points in the past, τᵢⱼ^{P}, as shown in Equation (8) below; future, τᵢⱼ^{F}, as shown in Equation (9) below; or both, τᵢⱼ^{A}, as shown in Equation (10) below.

τᵢⱼ^{P}=tᵢ−tⱼ (8)

τᵢⱼ^{F}=tⱼ−tᵢ (9)

τᵢⱼ^{A}=abs(tᵢ−tⱼ) (10)

Once the neighborhood has been determined based on the model search algorithm, the method 100 can integrate additive manufacturing model kernel functions for the principal point and its neighborhood(s) (Block 122). There are several kernel functions that can be evaluated by the method 100, such as melt pool dimensions, velocity, lack of fusion, or thermal rise, to produce the PMs that are associated with a given principal point i. While these calculations will be discussed in greater detail below, this disclosure is not limited to evaluating only these kernel functions.

For the example of PBF-LB/M additive manufacturing, the patterned movement of the laser across the feedstock creates a melt pool that fuses the powder to the substrate. The melt pool dimensions can be estimated from the material properties and process parameters. As PMs, the melt pool depth, Dᵢ, and width, Wᵢ, can be calculated for each principal point from Equation (11) and Equation (12) below, respectively. For example, in Equation (11), A is the absorptivity; P is the wattage of the incident heat source; ρ is the bulk material density; cₚ is the bulk material specific heat capacity; Vᵢⱼ is the velocity of the melt pool; Tₘ is the melting temperature of the material; T₀ is the substrate temperature; and e is Euler's number.

$${D}_{i} = \sqrt{\frac{2 {AP}_{i}}{e π ρ {c}_{p} ( {T}_{m} - {T}_{0} ) {V}_{ij}}} \qquad ( 12 )$$

$${W}_{i} = 2 {D}_{i}$$

The process model of the melt pool velocity is taken to be equivalent to the velocity of the laser spot. The neighborhood search algorithm for the melt pool velocity PM is j equal to i−1 and the kernel function is rᵢⱼ over τᵢⱼ^{P} as shown in Equation (13) below.

Vᵢⱼ=rᵢⱼ/τᵢⱼ^{P} (13)

An additive manufacturing process model can indicate if lack of fusion porosity occurs when the melt pool shape is too small to overlap for a given hatch spacing and layer height. A lack of fusion model can be calculated as one of the PMs, or criterion, for each principal point i once the hatch spacing and layer heights are known at each principal point i. The hatch spacing metric requires a distance measurement to be taken between the principal point i and its nearest neighbor j within the parallel adjacent melt track. To calculate the hatch spacing at each principal point i, a neighborhood model search algorithm must be used such that the neighborhood consists of only the nearest neighbor within the parallel adjacent melt track.

In one example, the neighborhood model search algorithm could be 3π/2>abs(θᵢ^{H}−θⱼ^{H})>π/2 and rᵢⱼ<rᵢₖ, where k is j−1 for dzᵢⱼ≈0. The absolute value of the hatch angle difference being less than 3π/2 and greater than π/2 ensured that the neighbor point was on a separate melt track of the meander hatch pattern. The angle θᵢⱼ relative to the x-axis at each principal point was calculated from arctangent of dyᵢⱼ over dxᵢⱼ as shown in Equation (14) below. The angle relative to the x-axis is a phase sensitive hatch angle, θᵢ^{H}, when θᵢⱼ is equal to θᵢₖ, where k is i−1. The equation of distance for a point from a line was the kernel function between the principal point i and the neighborhood, as shown in Equation (15) below. The resulting point focus driven PM provides the hatch distance at each principal point.

$${θ}_{ij} = arctan ( \frac{{dy}_{ij}}{{dx}_{ij}} ) \qquad ( 14 )$$

$${f}_{ij}^{H} = \vert cos ( {θ}_{i}^{H} ) {dy}_{ij} - sin ( {θ}_{i}^{H} ) {dx}_{ij} \vert \qquad ( 15 )$$

The inter layer thickness at the principal point, dzᵢⱼ^{H}, was determined using a search algorithm such that dzᵢⱼ, as shown in Equation (7), is a minimum value greater than zero. A threshold value of 1 for lᵢⱼ in the lack of fusion criterion additive manufacturing model indicates that lack of fusion porosity will occur. The lᵢⱼ PM can be calculated for each principal point i using Equation (16) (below) once the calculated melt pool dimensions, hatch spacing, and inter-layer thickness are known at each principal point i.

$${l}_{ij} = {( \frac{{f}_{ij}^{H}}{{W}_{i}} )}^{2} + {( \frac{{dz}_{ij}^{H}}{{D}_{i}} )}^{2} \qquad ( 16 )$$

A kernel function for a thermal rise PM is defined as a temperature increase relative to a reference, such as ambient temperature. The PM can be used to determine a point field driven thermal rise at each principal point. In one example, the thermal rise can be calculated from a discrete heat source additive manufacturing process model utilizing a non-constant kernel function where ν is the sampling frequency, σ is the radius of the heat source, and α is the thermal diffusivity of the material, as shown in Equation (17) below. The thermal rise PM can be interpreted as a transient measure of localized pre-heat temperature when a time delay, tᵢ^{delay}, term is utilized and τᵢⱼ is defined by Equation (8). In one example, a time delay, such as 157 μs, could be chosen such that the neighborhood search algorithm includes only points that are behind the incident heat source by a distance calculated by multiplying 157 μs by Vᵢⱼ. Additionally, when computing one of the melt pool dimensions, a computed value for the thermal rise can be used as the substrate temperature in Equation (11).

$${f}_{ij}^{G} = \frac{{AP}_{j}}{{v}_{j} ρ {c}_{p} \sqrt{2} {{π}^{\frac{2}{3}} ( {σ}_{j}^{2} + 2 α {τ}_{ij} )}^{\frac{2}{3}}} {exp}^{\frac{- {r}_{ij}^{2}}{2 ( {σ}_{j}^{2} + 2 a {τ}_{ij} )}} \qquad ( 17 )$$

If there are additional principal points i to assess from the point field (Block 124), the method 100 can return to Block 118 to evaluate each of the additional principal points i until all of the principal points in the point field have been evaluated. If there are no additional principal points to evaluate, the method 100 continues to Block 126. At Block 126, the method 100 has taken the computed PMs and associated each of them with each of the corresponding points in the point field(s) from Block 114. This will provide PMs for each point in the point field that was subject to calculations through the process enclosed by the Block 116.

If the method 100 computed PMs for the model-based point field and at least one measure-based point field (Block 128), the method 100 can create a comparison of the PMs from the two different point fields. The method 100 can create the comparison by creating a PM differences point field with corresponding points representing the differences in computed PMs between the model-based point field and the measure-based point field at Block 130 or multiple measure-based point fields.

In this disclosure, the model-based point field, the measure-based point field(s), and PM difference point field include corresponding points to allow for comparison of the PMs. In one example, if the PM being compared is velocity, then the method 100 will compare the velocity PM computed for the model-based point field with the velocity PM computed from a corresponding point for the measure-based point field and assign that value to a corresponding point in the PM differences point field. In one example, corresponding points are determined by nearest neighbor in spatial coordinates.

A difference in computed PMs will highlight where the variations in PMs occurred between the model and the additively manufactured component. Comparisons of other PMs, such as power, melt pool width Wᵢ, melt pool depth Dᵢ, lack of fusion, or thermal rise, can also be generated between the corresponding points.

As shown in FIG. 1, the computer system 50 can generate a separate graphical representation on the screen 62 of the computer PMs for the model-based point field 64-MOD, the measure-based point field 64-MEA, and the PM differences point field 64-D. In one example, the graphical representations of the model-based point field 64-MOD and the measure-based point field 64-MEA have the same gradient scale and graphical representation of the PM differences point field 64-D has a gradient scale showing the difference from the computed MPs of one of the model-based point field or the measure-based point field. The graphical representation of the PM differences point field 64-D can highlight the differences between the computed PMs for the model-based point field and the measure-based point field that can provide information to aid in improving build quality and identifying potential operational issues with the additive manufacturing system 20 for the component 22.

Once the method 100 has computed PMs associated with at least one of the model-based point field or the measure-based point field, the method 100 can determine if the build file for the component 22 should be modified (Block 132). The method 100 can also use the PM differences point field if one was generated to assist in determining if the build file should be modified. To determine if the build file should be modified, the method 100 can evaluate if any of the PMs or PM differences from the point fields are within a predetermined range for the given PM. If the values are within the range, the method 100 may determine that modifying the build file is not necessary and complete the method at Block 136.

If the values are not within the range, the method 100 may determine that the build file should be modified. If the method 100 determines that the build file should be modified, the method 100 proceeds to Block 134 to modify the build file. The build file can be modified using the computed values for the model-based point field, the computed values for the measure-based point field, or the PM differences point field. These point fields can be used to improve the build file to ensure that the PMs for the modified build file fall within the predetermined range.

Once the modified build file has been generated, the method 100 can return to Block 104 and perform the above-described process based on the modified build file. Also, the computer system 50 could instruct the additive manufacturing system 20 to build a modified component based on the modified build file to provide an iterative evaluation of the component.

Additionally, the parallel and scalable calculation design of the process described within Block 116 and the direct comparison of the computed values for the model-based point field with the measure-based point field discussed above and shown in FIG. 3 are advantages of the point field and PM approach to additive manufacturing modeling and assessment. The computational speed of calculating the PMs enables iterative assessment and tuning of additively manufactured components using the point focused PMs. This allows for several rounds of build files to be evaluated before a single component is ever built and further refinements to be made when PMs are calculated for the measure-based point field for the component to be compared to the calculated PMs for the model-based point field.

Moving on to a new discussion, a meandering hatch pattern is used to conduct a multitude of sequential welds during the PBF-LB/M AM process. An inter-layer hatch angle rotation to the meandering hatch pattern from one layer to the next is widely practiced for mitigating significant porosity that often occurs when no hatch rotation is used. For example, an inter-layer hatch angle will progress with a rotation of 17 degrees as a default setting found in PBF-LB/M build-file generating software.

A power, velocity, hatch, and layer thickness parameter set are often used to define a build strategy. These parameters combine in the PBF-LB/M AM process to consolidate the material, weld upon weld and layer upon layer. Parameters tuned for a particular material are expected to produce a fully consolidated component, no porosity.

The hatch rotation is a tunable parameter but is only capable of continuous rotations in the build software. As a result, the hatch angle, and its progression angle, start at a particular value and sequentially rotate with the specified step size continuously throughout the build.

The hatch angle is the angle of the weld line relative to the build's reference-axis. The strict calculation of the hatch angle is phase sensitive to the direction of the meandering weld, i.e., the hatch angle of two adjacent welds in the hatch pattern will have hatch angles with a difference of π. When build files are generated, this directional phase sensitivity is ignored and all welds in a meandering hatch are considered to have the same hatch angle. A hatch progresses from the first weld to the last weld in sequence.

The hatch progression angle is perpendicular and phased in sequence to the hatch angle. A meandering hatch of welds progresses from one side of a component layer to another, along a progression vector. The hatch progression angle is the angle of the progression vector relative to the build's reference axis.

Crossflow gas velocity is consistent along an axis of the PBF-LB/M process that is perpendicular to the spreader axis. The crossflow G (FIG. 1) blows the spatter directionally along its axis, from the gas outlet grill 47 to the gas inlet grill 48. This directionality and axis orientation are termed the crossflow vector and are used as the build reference axis herein.

When setting the build's reference axis to be that of the crossflow vector, the hatch progression angle can be used to design build files that mitigate spatter induced porosity by enforcing a hatch progression angle with a trigonometric function that is based on the coordinates and crossflow reference axis of the PBF-LB/M additive manufacturing system 20. Thus, the trigonometric function of the hatch progression angle can be used as a tactical device for developing build strategies and in the generation of build files for PBF-LB/M. In the non-limiting examples of the present disclosure, a cosine trigonometric function is used. In alternative embodiments, a sine trigonometric function may also be used. For the examples of present disclosure, the use of cosine of the hatch progression angle restricted between −1 and 0 can be used to avoid porosity generating mechanisms that are more likely to occur when the progression is vectoring with the crossflow. As such, spatter induced porosity can be influenced by the hatch progression angle design. The general form of process metrics has been discussed above with respect to Equations (1)-(10).

In general, the trigonometric function is used to determine the progression relative to the crossflow, i.e., the choice of −1 to 0 for cosine of the hatch progression angel is due to the coordinates of the process input and feedback relative to the crossflow orientation and position. If the crossflow direction was to be reversed, cos(θ) would be enforced between 0 and 1. Or, the crossflow direction was rotated by 90°, then sin(θ) would be enforced between −1 and 0, etc. Additionally, a more refined selection of the hatch progression angle may be determined within those bounds.

For the “scatter exposure” process metric, the PM calculation is the convolution of a non-constant kernel function, fᵢⱼ, with the neighborhood of the principal point, Øᵢⱼ, as shown in Equation (1). A PMᵢ is the calculated PM value at each principal point i. The chosen kernel function and neighborhood search algorithm are defined by the physical model of the AM process that is being considered for each principal point in the PF 60.

As previously discussed, the neighborhood is determined for each principal point by a search algorithm, or function set, Øᵢⱼ. The distance, rᵢⱼ, between the principal i and the neighborhood point j is calculated using the three-dimensional (3D) cartesian coordinate distance, as represented in Equation (3). Relative to the principal point, the neighborhood may be composed of points in the past, τᵢⱼ^{P}, as represented in Equation (8); and future, τᵢⱼ^{F}, as represented in Equation (9). For a hatch progression angle process metric, the hatch progression angle, as represented in Equation (22) below, can be calculated using a neighborhood search function set, as represented in Equation (18) below, with the kernel functions, Equations (19)-(21) below.

$${∅}_{ij} = \{ \text{} \begin{matrix}1 & if {r}_{ij} \leq {R}_{i} and {τ}_{ij} \geq {t}_{i}^{delay} and \\ & \frac{3 π}{2} > abs ( {θ}_{i}^{H} - {θ}_{j}^{H} ) > \frac{π}{2} and {dz}_{ij} = 0 \\ 0 & else\end{matrix} \qquad ( 18 )$$

$${f}_{ij}^{Hpx} = {x}_{j} \qquad ( 19 )$$

$${f}_{ij}^{Hpy} = {y}_{j} \qquad ( 20 )$$

$${f}_{ij}^{Hpc} = 1 \qquad ( 21 )$$

$${PM}_{i}^{Hp} = {tan}^{- 1} ( \frac{{y}_{i} {-}^{{PM}_{i}^{Hpy}} {/}_{{PM}_{i}^{Hpc}}}{{x}_{i} {-}^{{PM}_{i}^{Hpx}} {/}_{{PM}_{i}^{Hpc}}} ) \qquad ( 22 )$$

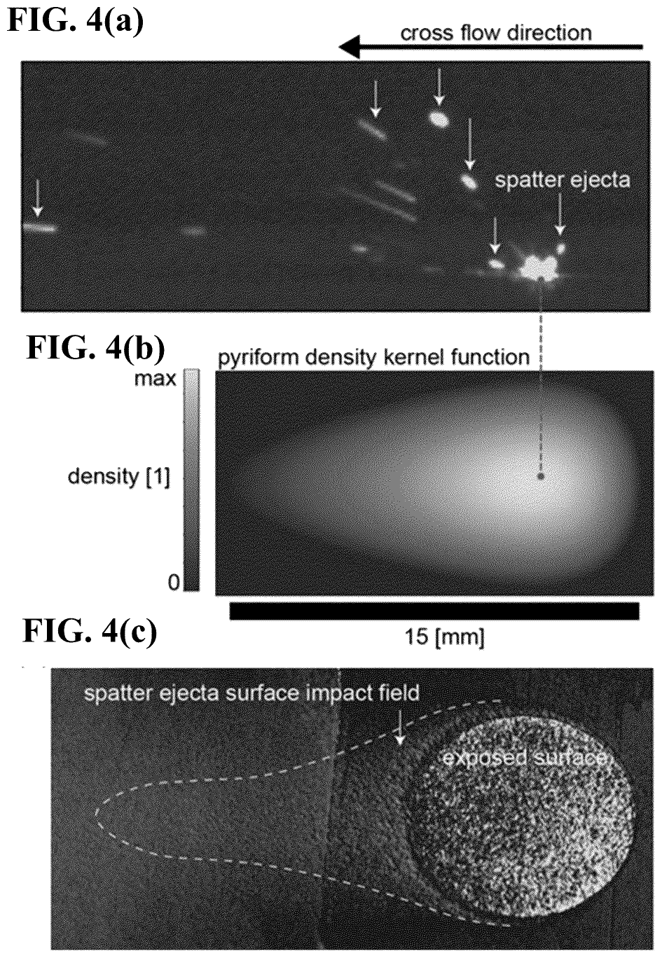

The spatter exposure process metric, as represented in Equation (30) below, has been developed to quantify the exposure of the powder surface to in-layer stochastic spatter ejecta. The spatter exposure PM reflects an accumulation of the stochastic opportunity for large spatter ejecta to land upon the powder and be partially welded to the sub-surface. Without a crossflow, the spatter ejecta surface impacts are assumed to follow a gaussian distribution that decays with distance. The crossflow is applied during the PBF-LB/M process to influence the welding plume and spatter ejecta. For example, FIGS. 4(a)-4(c) provide illustrations of spatter characteristics (a) being influenced by the crossflow direction during the PBF-LB/M process, (b) pyriform density field describing stochastic surface impacts, and (c) a post-exposure layer intensity color-mapped photograph with the spatter ejecta surface impact field and exposed surface indicated (where the photograph is reproduced in black and white for the present patent application).

Accordingly, the crossflow is directional and necessarily effects the trajectories of the spatter ejecta. The crossflow directionality distorts the assumed gaussian distribution of spatter ejecta surface impacts such that a pyriform distribution may be appropriate with a tail direction aligned with the crossflow direction, as illustrated in FIG. 4(c). The pyriform kernel function models the decaying and elongated density of surface impact for spatter ejecta aligned with the crossflow and based on the position, proximity, and sequence of each point downstream in the process.

The pyriform form of the universal equation of an egg was adapted as a kernel function for the spatter exposure PM, as illustrated in FIG. 4(b) and represented in Equation (29) below. The neighborhood, as represented in Equation (23) below, consists of in-layer points, points in the past, τᵢⱼ^{P}, and the chosen neighborhood radius Rᵢ. The components of that equation are detailed in Equations (24)-(29). The length of the pyriform is given by L, as represented in Equation (24). L was determined to be 3/2 of the neighborhood radius Rᵢ. The maximum breadth of the shape is given by B, and was determined to be ½ L, as represented in Equation (25). The distance between the vertical lines corresponding to the maximum breadth and the half length of the pyriform shape is given by w, which was determined to be L/5, as represented in Equation (26). The pyriform shape adjusted distance between the principal point and the neighbor point is given by ζ, where dyᵢⱼ is the crossflow axis, and the flow direction is from negative to positive along the y-axis, as represented in Equation (27). The shape adjustment was a subtraction of L/4, such that the highest intensity value of the resulting pyriform is coincident with the principal point. The kernel function, as represented in Equation (29) is the pyriform equation values for ζ and γ that are below zero, such that they are the values within the pyriform shape, adjusted by the point density ratio of speed over sampling frequency, and a negative scaling factor, as illustrated in FIG. 4(b).

$${∅}_{ij} = \{ \begin{matrix}1 & if {r}_{ij} \leq {R}_{i} and {τ}_{ij} \geq {t}_{i}^{delay} and {dz}_{ij} = 0 \\ 0 & else\end{matrix} \qquad ( 23 )$$

$$L = \frac{3}{2} \qquad ( 24 )$$

$$B = \frac{L}{2} \qquad ( 25 )$$

$$W = \frac{L}{5} \qquad ( 26 )$$

$$ζ = {dy}_{ij} - \frac{L}{4} \qquad ( 27 )$$

$$γ = {dx}_{ij} \qquad ( 28 )$$

$${f}_{ij}^{S} = - 1 * ( {γ}^{2} - \frac{{w}^{2}}{4} \frac{( {L}^{2} - 4 ζ ) L}{2 ( L - 2 w ) {ζ}^{2} + ( {L}^{2} + 8 w L - 4 {w}^{2} ) ζ + 2 L {w}^{2} + {L}^{2} w + {L}^{3}} < 0 ) \frac{{V}_{j}}{{v}_{j}} \qquad ( 29 )$$

$${PM}_{i}^{S} = {\sum }_{j}^{N} {f}_{ij}^{S} {∅}_{ij}^{S} \qquad ( 30 )$$

The neighborhood radius, Rᵢ, is used to define the characteristic length of the spatter exposure metric. The neighborhood radius, Rᵢ, can range from 1 [mm] to 50 [mm]. A Rᵢ of 10 [mm] was used herein to calculate the spatter exposure process metric, PMᵢ^{S}.

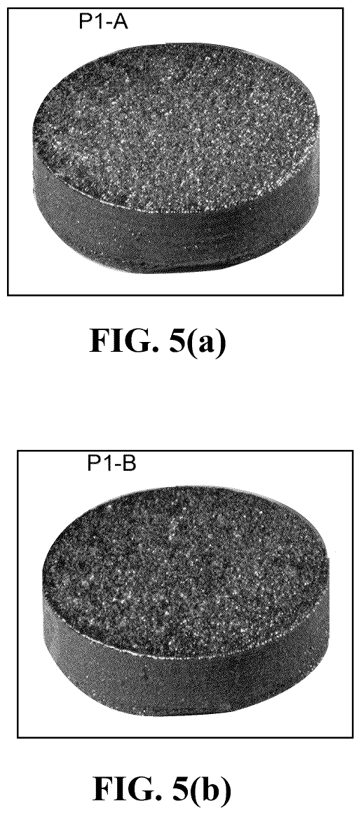

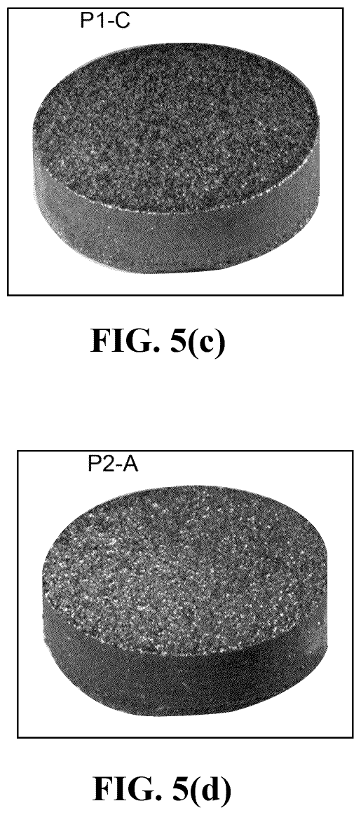

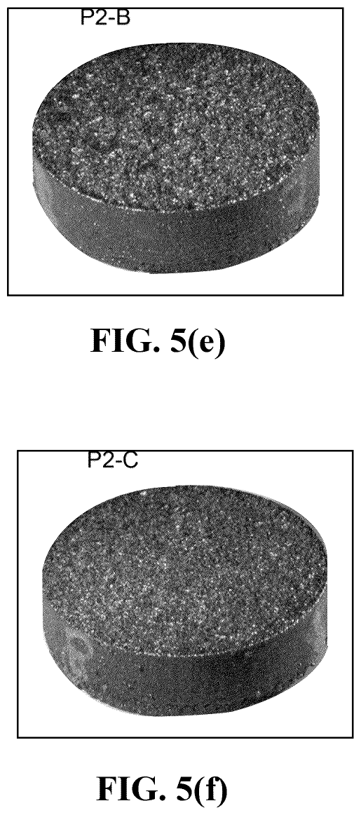

Two sets of processing parameters were used to print a total of six specimens, as shown in Table 1 below and FIGS. 5(a)-5(f). Parameter set P1 used a power of 350 W, speed of 1400 mm/s, hatch spacing of 0.1 mm, and inter-layer height of 0.05 mm. Parameter set P2 used a power of 240 W, speed of 1400 mm/s, hatch spacing of 0.1 mm, and inter-layer height of 0.05 mm. The P2 specimens were built with a lower surface energy density than the P1 specimens to increase the process sensitivity to local layer thickness deviations that can induce porosity. Three types of hatching strategy were applied to each parameter set. The variable being controlled was the hatch progression angle. Type A hatching strategy used a layer-wise hatch progression angle step of 0.297 radian (17 degrees), with a starting hatch progression angle of 0 radian. Type B hatching strategy was a filtered Type A hatching strategy where the hatch progression angles were filtered to cosine values between 0 and 1. Type C hatching strategy was a filtered Type A hatching strategy where the hatch progression angles were filtered to cosine values between −1 and 0. Due to the orientation of the printer axes, the cosine value of −1 for the hatch progression angle results in weld hatching that sequentially approaches the crossflow outlet, going opposite the crossflow direction. Conversely, the cosine value of 1 for the hatch progression angle results in weld hatching that sequentially approaches the crossflow inlet, going along the crossflow direction. The Type A hatching strategy contains all hatch progression angles in full rotation, six full rotations, such that their cosine values range from −1 to 1. The hatch progression angle was used to test the effect that progression of the hatch welding lines relative to the crossflow has on the porosity generation with the specimens.

TABLE 1

| | | | Minimum | Maximum |
|---|---|---|---|---|
| | Power | Speed | cos (PM^{Hp}) | cos (PM^{Hp}) |
| ID | [W] | [mm/s] | [1] | [1] |
| P1-A | 350 | 1400 | −1 | 1 |
| P1-B | 350 | 1400 | 0 | 1 |
| P1-C | 350 | 1400 | −1 | 0 |
| P2-A | 240 | 1400 | −1 | 1 |
| P2-B | 240 | 1400 | 0 | 1 |
| P2-C | 240 | 1400 | −1 | 0 |

A configurable additive testbed (CAT) was used for building and recording the measured point field (PF). The term configurable implies that both hardware and software can be re-designed to facilitate experiments that support additive manufacturing research and development. The CAT was configured with an environmental chamber such that the build was done with <10 ppm O₂, measured using a PureAire® trace oxygen analyzer. A SCANLAB® GmbH IntelliScan® III 20 galvanometer head was driven by a SCANLAB® RTC6™ control board and an IPG Photonics® modulated continuous emission 1070 nm laser with a maximum power of 1 kW to conduct the build steps, fusing the feedstock in the PBF-LB/M AM manner. The feedstock was a titanium alloy Ti-6A1-4V atomized spherical powder, 53±15 μm, sourced from ATI®. A Jenoptik® F-Theta lens with a 255 mm working distance was used for a near uniform laser spot diameter of 80 μm across the 25.4×25.4 mm build area.

For each point in the measured PF, the x-location was measured from the first galvanometer mirror return, the y-location was measured from the second galvanometer mirror return, time was metered by the RTC6 real time clock control board, and power was measured from the IPG Photonics® laser analog output using a LabJack™ T7 Pro™ and a 25 kHz sampling rate. The power measurements were synchronized with the location and time via triggers from the RTC6™ control board.

Post-fabrication imaging of the test article was executed using a Nikon® Metrology HMXST 225™ X-ray system. The system can resolve details down to 5 μm. System settings during data acquisition and volumetric reconstruction were a voltage of 190 kV, a current intensity of 57 μA, a focal spot size of 5 μm, a rotational step angle of 0.002 radians, and a reconstructed voxel resolution of 15.6 μm. The reconstruction was taken as X-ray computed tomography (XCT) data of the as-printed specimens.

A multi-step algorithm was used to threshold, label, and measure the porosity from within the specimens using the XCT data. A 3D gaussian filter applied to the XCT data was differenced from the XCT data. A threshold value of −15 and below was applied to the differenced XCT data to determine a feature mask. Small features and small holes, small defined by 9 voxels, were removed from the feature mask. The features in the feature mask was then labeled and measured using the scikit-image module (van der Walt et al., 2014). The labeled and measured feature mask was used for subsequent registration to the process point field and AM-PM analysis.

Registration of the XCT voxels to the PF was done by manual determination of 6 spatial coordinates from the PF that correspond to 6 voxel coordinates from the XCT. The least-squares optimal mapping was computed from these 6 correspondences of XCT to PF coordinates. Each point in the PF was mapped to its corresponding coordinates in the XCT data, and a rectilinear prism volume was evaluated for the presence of a labeled feature. The rectilinear prism volume extended below each PF point by 0.05 mm, and perpendicular to the hatch angle of each point by 0.05 mm in each direction and had a depth parallel with the hatch angle of each point defined by the distance of Vᵢ/νᵢ. If a labeled feature was detected in the prism volume, super-voxel, at the i^{th} point, then it was registered to that index in the PF.

A calculation of the porosity volume fraction was determined using the process point field volume and the volume associated with each pore. The total analysis volume was determined by summing each super-voxel prism volume. The total porosity volume was determined by summing the porosity volumes for each of the labeled pores. The total porosity volume was divided by the total analysis volume to determine the porosity fraction for each specimen.

A proximity to surface metric was calculated throughout the point field for all points, as represented in Equations (30)-(33), and normalized, as represented in Equation (34). The analysis volume was determined to be any point in the PF with a normalized proximity to surface metric less than 0.35. The analysis volume was selected to be within the bulk of the specimens, sub-surface. The top surface (top skin), side-wall surfaces, and bottom surface (bottom skin), were not considered in the statistical analysis of porosity and process metrics.

$${∅}_{ij}^{ps} = \{ \begin{matrix}1 if {r}_{ij} \leq {R}_{i} and {τ}_{ij}^{A} \geq 0 \\ 0 else\end{matrix} \qquad ( 31 )$$

$${f}_{ij}^{ps} = \frac{{V}_{j}}{{v}_{j}} \qquad ( 32 )$$

$${PM}_{i}^{ps} = \frac{{V}_{j}}{{v}_{j}} \qquad ( 33 )$$

$${PM}_{i}^{ps} = {\sum }_{j}^{N} {f}_{ij}^{ps} {∅}_{ij}^{ps} \qquad ( 34 )$$

$$= 1 - \frac{{PM}_{i}^{ps}}{{max}_{i ∈ N} {PM}_{i}^{ps}} \qquad ( 35 )$$

In examining the results, the specimens of type A were taken as the control for each of the process parameter sets, P1 and P2. Specimen P1-B showed an increase of 7% and 16% respectively in total pore volume and total pore count. Specimen P1-C showed a decrease of 57% and 52% respectively in total pore volume and total pore count. The P2 parameter set also showed a very similar trend. Specimen P2-B showed a decrease of 44% and 14% respectively in total pore volume and total pore count. Specimen P2-C showed a decrease of 78% and 49% respectively in total pore volume and total pore count. The analysis volume density, based on the pore volume fraction, of the analysis volumes ranged from 99.98% to 99.99% for the P1 specimens, and from 98.00% to 99.55% for the P2 specimens, as shown in Table 2 below.

TABLE 2

| | Total | | Pore | Bulk |
|---|---|---|---|---|
| | pore | Pore | Volume | Volume |
| | Volume | Count | Fraction | Density |
| ID | [mm³] | [1] | [1] | [%] |
| P1-A | 4.4e−1 | 2.5e3 | 1.7e−4 | 99.98 |
| P1-B | 4.7e−1 | 2.9e3 | 1.9e−4 | 99.98 |
| P1-C | 1.9e−1 | 1.2e3 | 7.4e−5 | 99.99 |
| P2-A | 5.0e1 | 1.4e4 | 2.0e−2 | 98.00 |
| P2-B | 2.8e1 | 1.2e4 | 1.1e−2 | 98.90 |
| P2-C | 1.1el | 7.1e3 | 4.5e−3 | 99.55 |

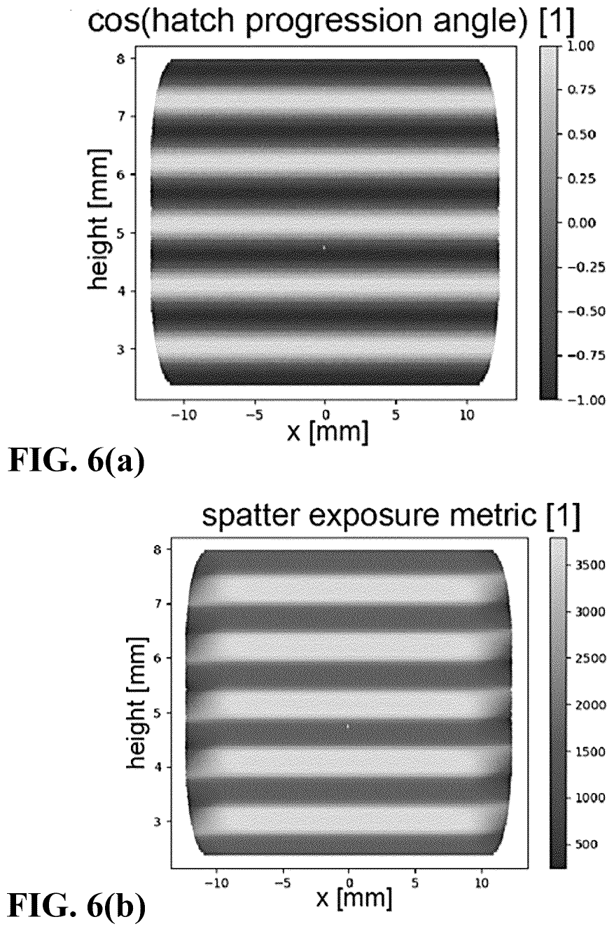

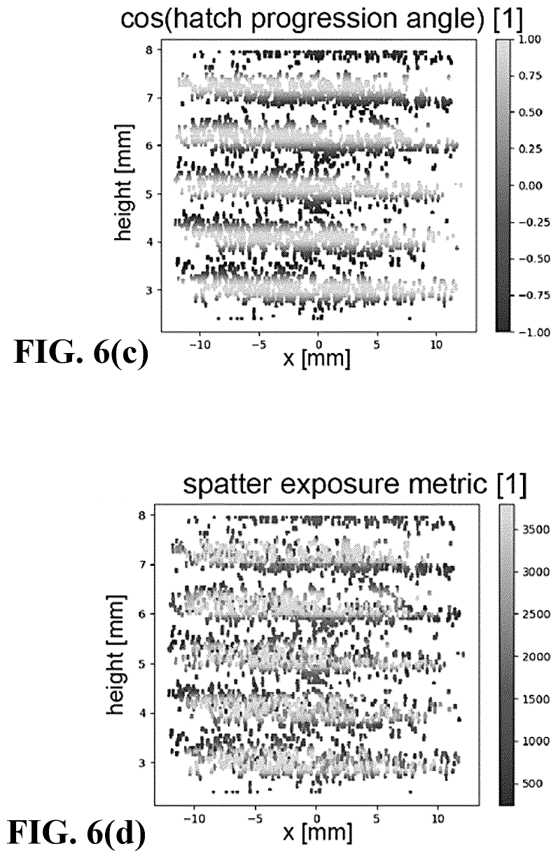

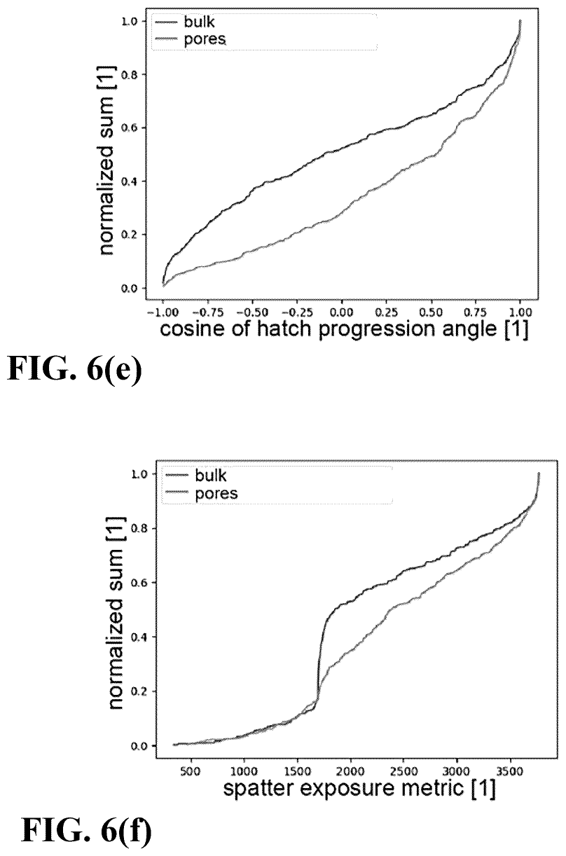

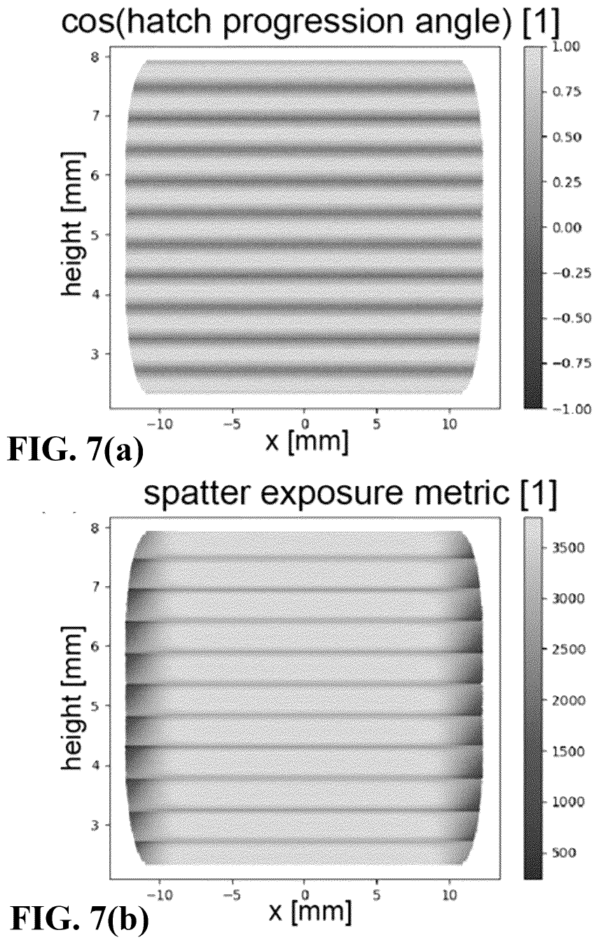

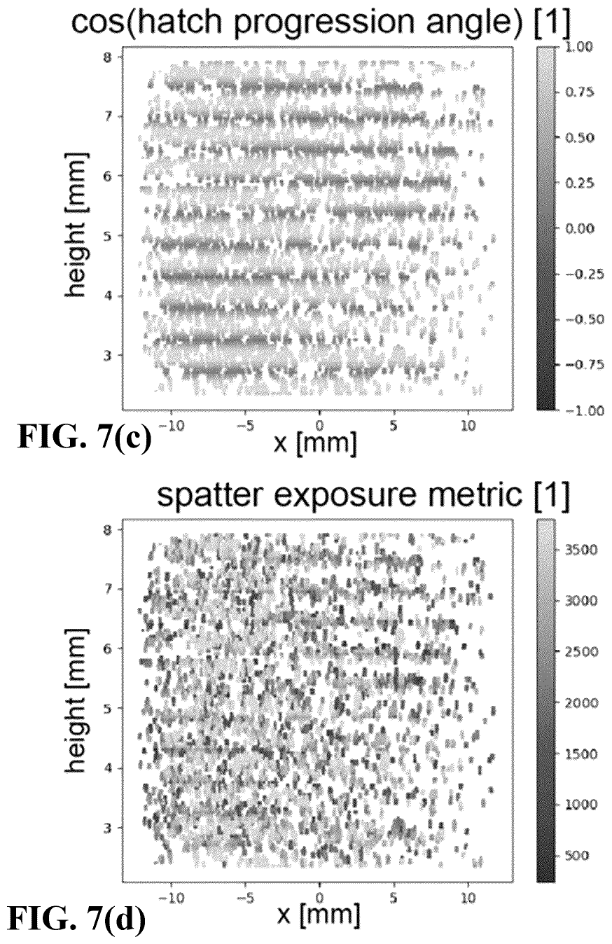

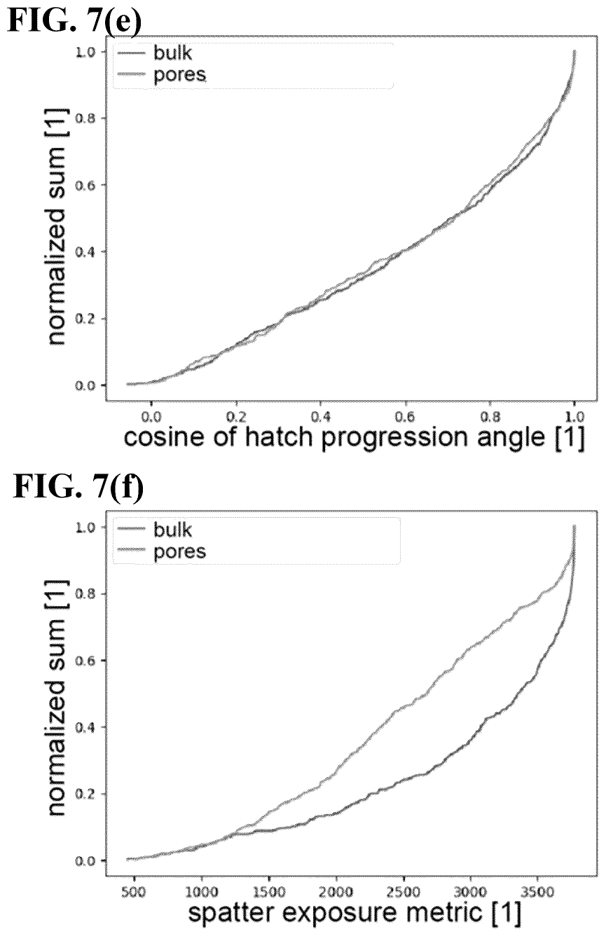

The cross-section of each specimen was taken to be the points of the PF where the y position was between 0.5 and −0.5 mm, as shown in FIGS. 6(a)-(b) to 11(a)-(b). The cross-section of each specimen was color-mapped to the specific process metrics where (a) is the cosine of the hatch progression angle metric, cos (PMᵢ^{Hp}), and (b) is the spatter exposure metric, PMᵢ^{S}. A single pore is observable in the cross-section plots of P1-A at the (x,y) position of (−0.1, 4.7) mm, as shown in FIGS. 6(a)-6(b). The cosine of the hatch progression angle color-mapped to the cross-section of the P1-A specimen shows a smooth wave of banding from −1 to 1 along the z-axis of the specimen, as shown in FIG. 6(a). The cosine of the hatch progression angle color-mapped to the cross-section of the P1-B specimen shows a jagged wave of banding from 0 to 1 along the z-axis of the specimen with a double frequency relative to the P1-A specimen, as shown in FIG. 7(a). The cosine of the hatch progression angle color-mapped to the cross-section of the P1-C specimen shows a jagged wave of banding from −1 to 0 along the z-axis of the specimen with a double frequency relative to the P1-A specimen, as shown in FIG. 7(a).

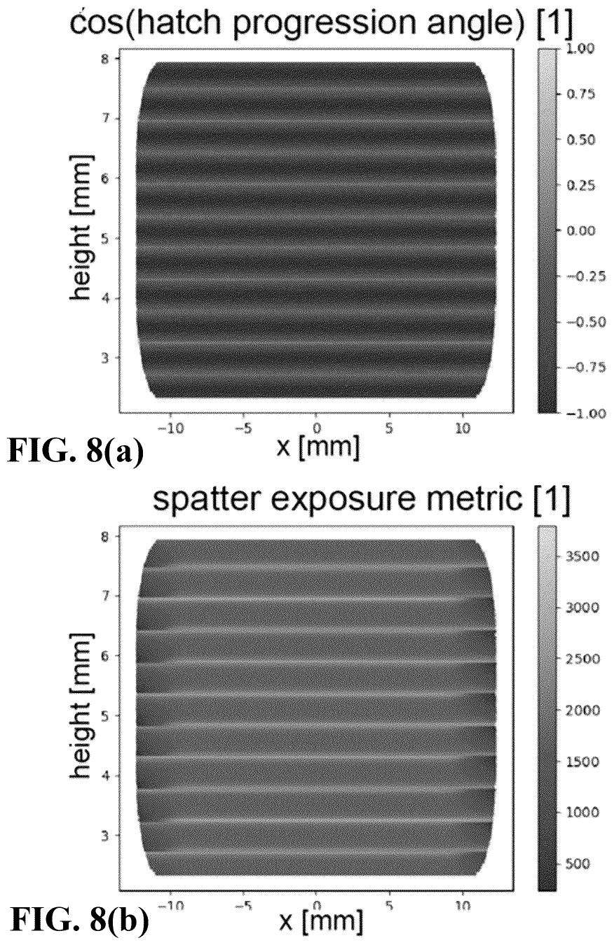

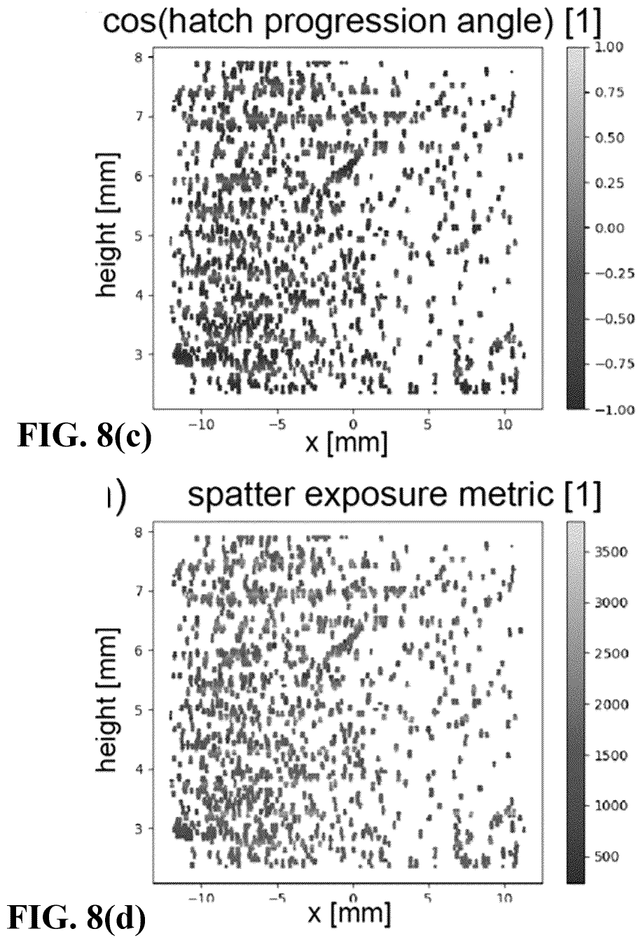

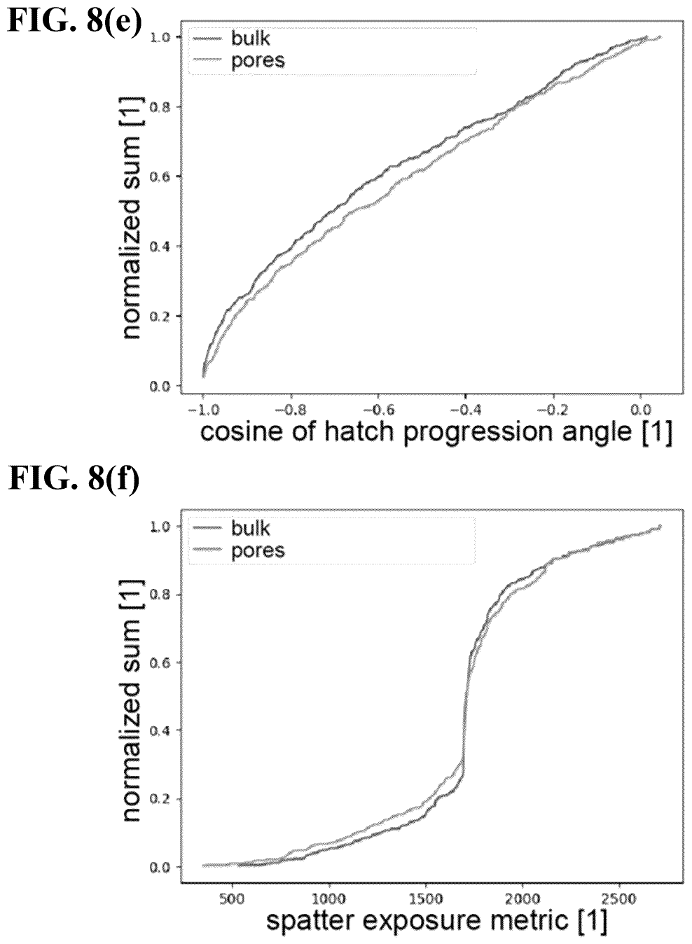

The pore registered points in the PF were all plotted along the x and z axes and color-mapped to the calculated process metrics, as shown in FIGS. 6(c)-(d) to 11(c)-(d), where (c) is the cosine of the hatch progression angle metric, cos (PMᵢ^{Hp}) and (d) is the spatter exposure metric, PMᵢ^{S}. The pores of specimen P1-A have an apparent density along the z-axis with a period of approximately 1.06 mm. The period of 1.06 mm matches the distance along the z-axis, layer wise, for the hatch progression angle to progress a full 2π rotation. There appears to be a slight banding feature in the porosity population along the z-axis with a periodic spacing of 0.53 mm in specimen P1-B, as shown in FIGS. 7(c)-7(d). There appears to be a very slight banding along the z-axis for the porosity population in specimen P1-C, with a periodic distance of 0.53 mm, as shown in FIGS. 8(c)-8(d). The distance of 0.53 mm matches the distance for the hatch progression angle to complete a π rotation progression. The cosine of the hatch progression angle, as shown in FIG. 6(c), and spatter exposure, as shown in FIG. 6(d) metrics appear to have a strong correlation with the banding feature in the P1-A specimen. For specimen P1-B, the cosine of the hatch progression angle metric, as shown in FIG. 7(c), does not appear to have a correlation with the slight banding feature. The spatter exposure metric, as shown in FIG. 7(d), does appear to have a correlation with the banding feature in the P1-B specimen. For specimen P1-C, neither the cosine of the hatch progression angle metric, as shown in FIG. 8(c), or the spatter exposure metric, as shown in FIG. 8(d), appear to have a correlation with the very slight banding feature along the z-axis.

A statistical analysis was performed on the bulk and pore populations throughout the PF for each specimen. A random sampling of 500 points was chosen for statistical analysis using the random choice module of the python NumPy package (Harris et al., 2020). Normalized cumulative distribution plots of the random sampling, as shown in FIGS. 6(e)-(f) to 11(e)-(f), where (e) is the cosine of the hatch progression angle metric, cos (PMᵢ^{Hp}) and (f) is the spatter exposure metric, PMᵢ^{S}, were used to map deviations between the bulk and pore process point populations. The pore population cosine of the hatch progression angle metric was heavily shifted to higher values compared with the bulk population, as shown in FIG. 6(e). The pore population spatter exposure metric deviated sharply from the bulk population at a value of 1750, as shown in FIG. 6(f). The pore and bulk populations were nearly identical for the cosine of the hatch progression metric in specimen P1-B, as shown in FIGS. 7(e)-7(f). The pore population spatter exposure metric deviated gradually from the bulk population starting at a value of 1250, as shown in FIG. 7(f). The pore and bulk populations were nearly identical for the considered metrics in specimen P1-C, as shown in FIGS. 8(e)-8(f).

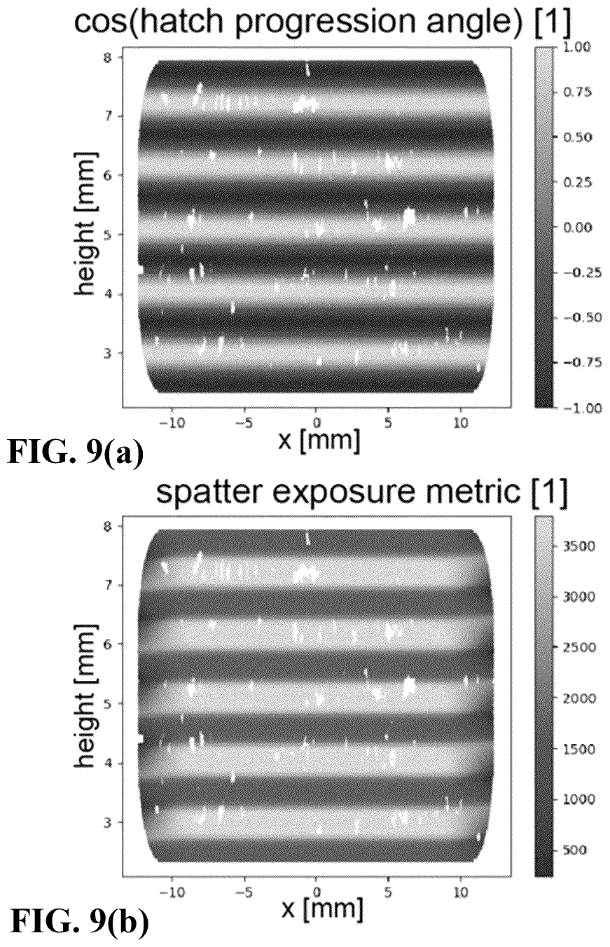

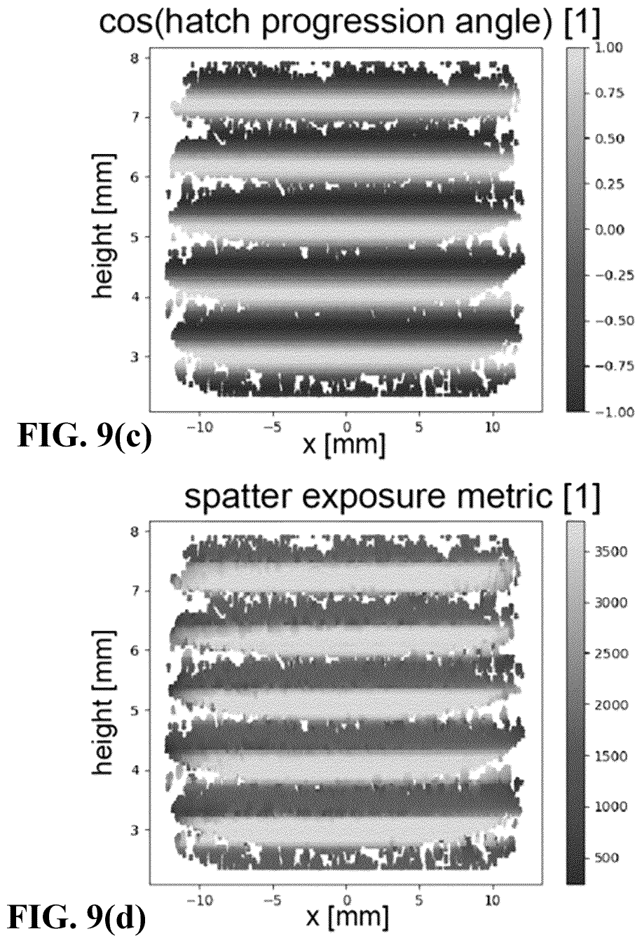

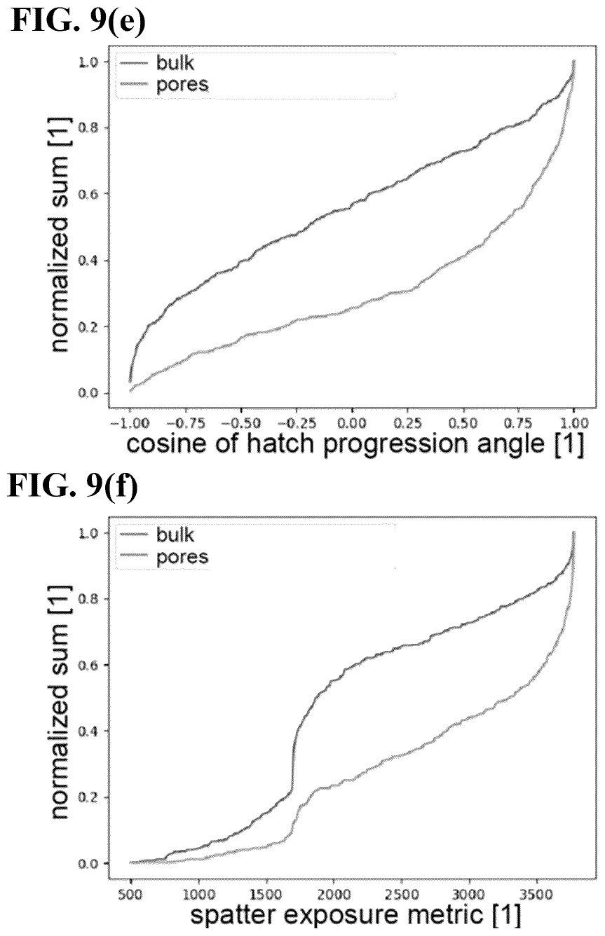

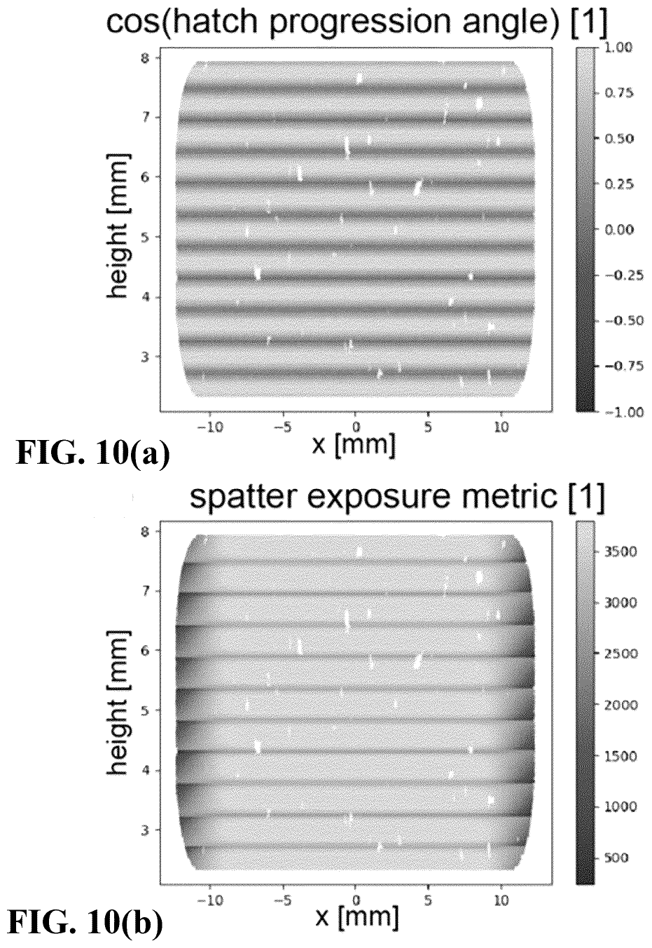

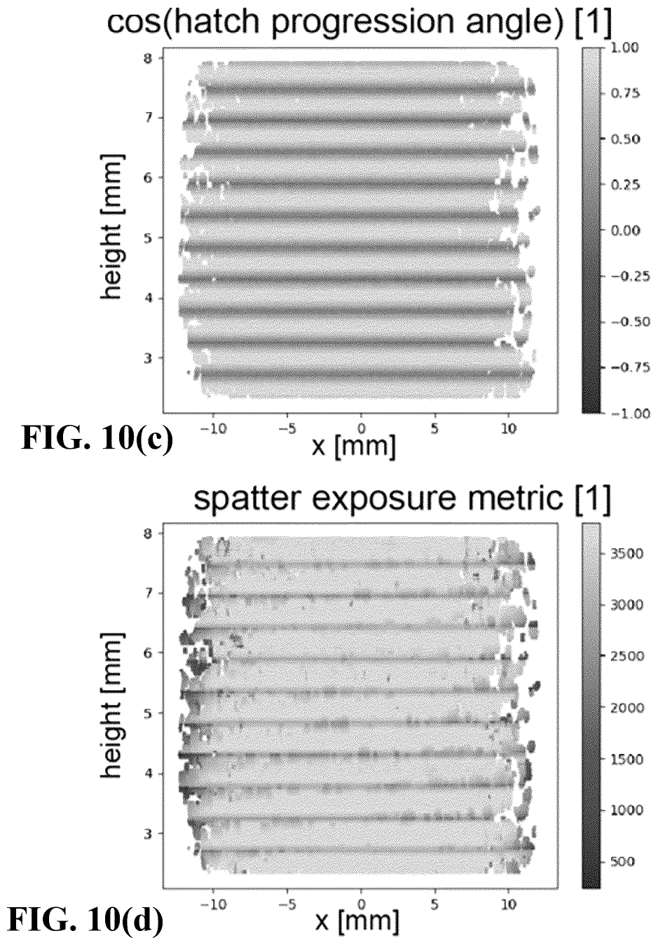

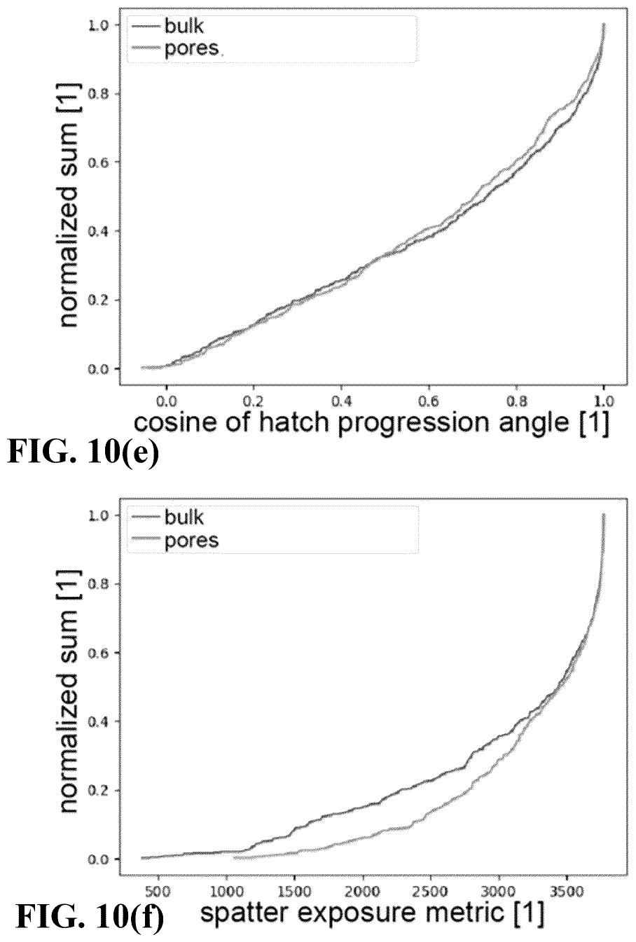

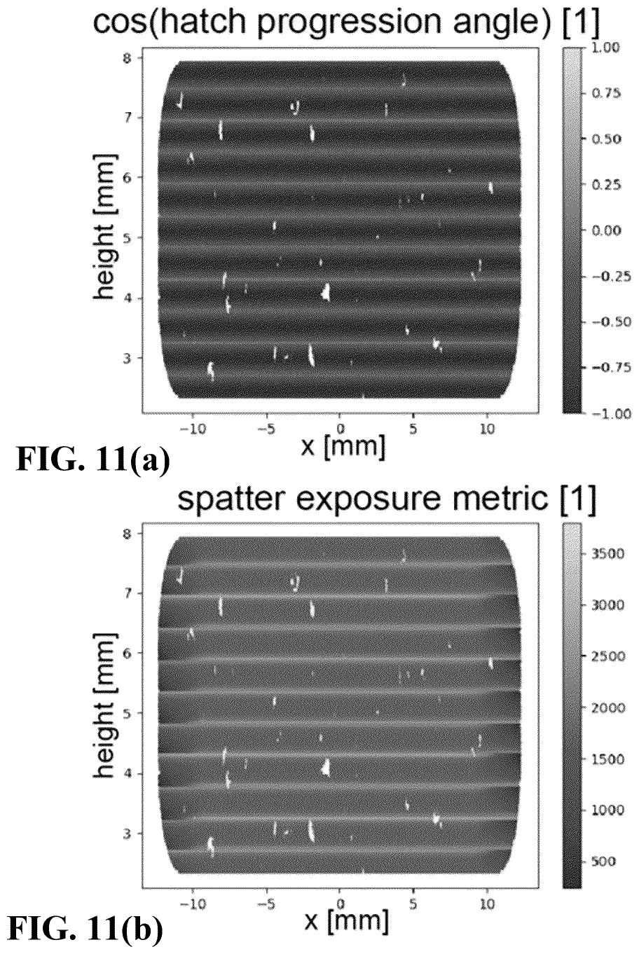

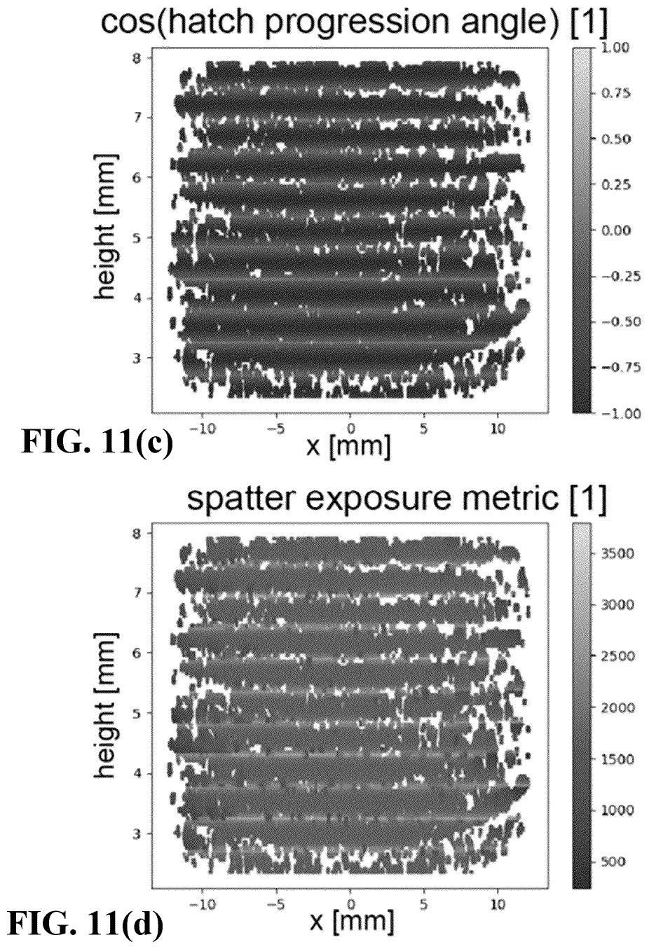

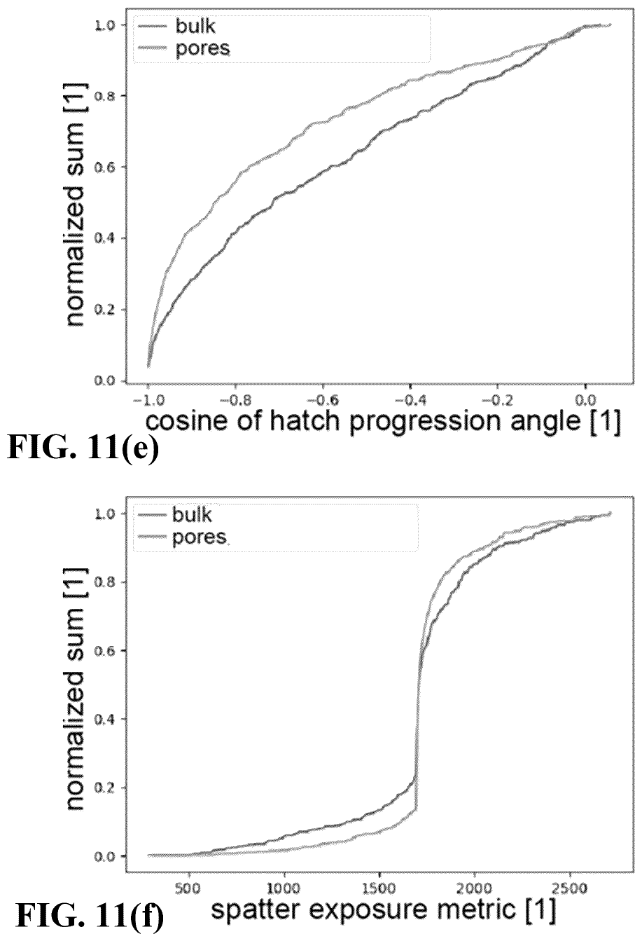

Pores are evident in the cross-section plots of the P2 specimens, as shown in FIGS. 9(a)-(f) to 11(a)-(f). The cosine of the hatch progression angle color-mapped to the cross-section of the P1-A specimen shows a smooth wave of banding from −1 to 1 along the z-axis of the specimen, as shown in FIG. 9(a). The cosine of the hatch progression angle color-mapped to the cross-section of the P1-B specimen shows a jagged wave of banding from 0 to 1 along the z-axis of the specimen with a double frequency relative to the P2-A specimen, as shown in FIG. 10(a). The cosine of the hatch progression angle color-mapped to the cross-section of the P2-C specimen shows a jagged wave of banding from −1 to 0 along the z-axis of the specimen with a double frequency relative to the P2-A specimen, as shown in FIG. 11(a).

The pores of specimen P2-A have an apparent density along the z-axis with a period of approximately 1.06 mm. The period of 1.06 mm matches the distance along the z-axis, layer wise, for the hatch progression angle to progress a full 2π rotation. The population of porosity registered points specimen P2-B is high, and no periodic trends, banding, were observable, as shown in FIGS. 7(c)-7(d). There appears to be a very slight banding along the z-axis for the porosity population in specimen P2-C, with a periodic distance of 0.53 mm, as shown in FIGS. 8(c)-8(d). The distance of 0.53 mm matches the distance for the hatch progression angle to complete a π rotation progression. For each specimen, as show in FIGS. 9(c)-(d) to 11(c)-(d), the cosine of the hatch progression angle, as shown in FIG. 9(c), and spatter exposure, as shown in FIG. 9(d) metrics appear to have a strong correlation with the banding feature in the P2-A specimen. For specimen P2-C, neither the cosine of the hatch progression angle metric, as shown in FIG. 11(c), and the spatter exposure metric, as shown in FIG. 11(d), appear to have some correlation with the banding along the z-axis.

The pore population cosine of the hatch progression angle metric was heavily shifted to higher values compared with the bulk population, as shown in FIG. 9(e). The pore population spatter exposure metric deviated gradually from the bulk population and both curves show sharp increase at a value of 1750, as shown in FIG. 9(f). The pore and bulk populations were nearly identical for the cosine of the hatch progression metric in specimen P2-B, as shown in FIG. 10(e). The pore population spatter exposure metric deviated gradually from the bulk population starting at a value of 1050, as shown in FIG. 10(f). The cosine of the hatch progression angle of the pore population showed a trend towards lower values versus the bulk population for the P2-C specimen, as shown in FIG. 11(e). The pore population spatter exposure metric was nearly identical to the bulk population in specimen P2-C, as shown in FIG. 11(f).

A Mann-Whitney U statistical test was used to test observed trends in process metrics for the pore versus bulk populations, as shown in Table 3 (below). A threshold of 99 percent confidence was used to determine rejection of the null hypothesis for each specimen and metric. For specimens P1-A and P2-A, the null hypothesis is rejected for the cosine of hatch progression angle and spatter exposure metrics. For specimen P1-B, the null hypothesis is rejected for the spatter exposure metric. For specimen P1-C and P2-B, the null hypothesis is accepted for all metrics. For specimen P2-C, the null hypothesis is rejected for the cosine of hatch progression metrics.

TABLE 3

| | | Spatter |
|---|---|---|
| | | exposure, |
| ID | cos(PM^{Hp}) | PM^{S} |
| P1-A | 0 | 3.8e−5 |
| P1-B | 6.9e−1 | 9.0e−17 |
| P1-C | 4.6e−2 | 7.1e−1 |
| P2-A | 1.4e−28 | 2.5e−27 |
| P2-B | 3.7e−1 | 4.4e−2 |
| P2-C | 1.2e−7 | 8.4e−1 |

The specimens printed with the P1 parameters of speed, power, and hatch spacing represent ideal printing parameters. The specimens printed with the P2 parameters of speed, power, and hatch spacing are non-ideal parameters that produce a surface energy density that is lower than that of the P1 parameters.

The type A, specimens P1-A and P2-A, were the control specimen type for both parameter sets, as it is a common practice for print design software to rotate the hatch progression angle continuously through full 2π rotations when generating build files. Both P1-A and P2-A specimens showed distinct layer wise banding along the z-axis. The null hypothesis was accepted for the thermal rise and lack of fusion metrics for both control specimens. Since the power, speed, and hatch spacing were parametrically unchanged throughout the build, the lack of fusion metric was expected to be very uniform throughout the specimen. The thermal rise is sensitive to specific hatch lengths and sequence as are defined by the combination of build parameters with the specimen geometry. The geometry is cylindrical, so each layer is expected to have a relatively uniform thermal rise pattern as the hatching is applied in a rotating pattern within a circle. The null hypothesis between the pore population and bulk population was refuted with greater than 99% confidence for the cosine of the hatch progression angle and spatter exposure metrics. These metrics are sensitive to the sequence of the individual points of the process PF and their orientation relative to the crossflow. In effect, the porosity is higher when the hatch progression is proceeding with the crossflow, and lower when the hatch progression is proceeding opposite with the crossflow. The porosity correlation with crossflow can be physically understood as a function of spatter since the function of crossflow is to remove the cloud of spatter from the path of the laser in PBF-LB/M. The hatch progression angle can be used to correlate, understand, and control the symptom of porosity being induced by the interaction of spatter, crossflow, and weld sequence. The greater population of porosity existing with a cosine of the hatch progression angle metric between 0 and 1 shows that the pores are formed when large spatter ejecta lands on unexposed powder and is subsequently welded within the same layer.

Spatter consists of droplets of molten metal that are ejected during the PBF-LB/M welding process. When spatter is large and partially welded to the surface, it can shield a preceding layer from fusing with subsequent layers and resulting in spatter induced porosity. The spatter exposure metric is a summation of a threshold of the equation for a pyriform and is thus an analytical value that is sensitive to the point-wise spatter ejecta variables of sequence, distance, and alignment with the crossflow between each point and all neighboring points in the layer, where each point is a discrete welding event during the hatching of the PBF-LB/M process. The spatter is stochastic in molten ejecta size and direction. The spatter exposure metric is a relative intensity of opportunity for a spatter ejecta to land on un-exposed powder prior to welding during PBF-LB/M. The spatter exposure metric was formulated based upon the observed trends in progression from the hatch progression angle and porosity, and the stochastic nature of the spatter.

Specimens of type B were printed with a cosine of the hatch progression angle restricted between 0 and 1, to emphasize the hypothesized spatter induced porosity generating mechanism. The total porosity count was increased by 16% for P1 and decreased by 14% for P2. The null hypothesis comparing the porosity and bulk populations was rejected for the spatter exposure metric for the P1 specimen. The null hypothesis rejection of the spatter exposure metric but not the cosine of the hatch progression angle indicates that the spatter exposure metric is precisely sensitive to the point-wise phenomena of spatter induced porosity. Conversely, the null hypothesis was accepted for both metrics of the P2-B specimen. The P2-B specimen is porous throughout, and the precise approach here may not be a suitable diagnostic tool due to the lower energy conditions being emphasized by the progression angle restriction between 0 and 1, and the large porosity population throughout the specimen.

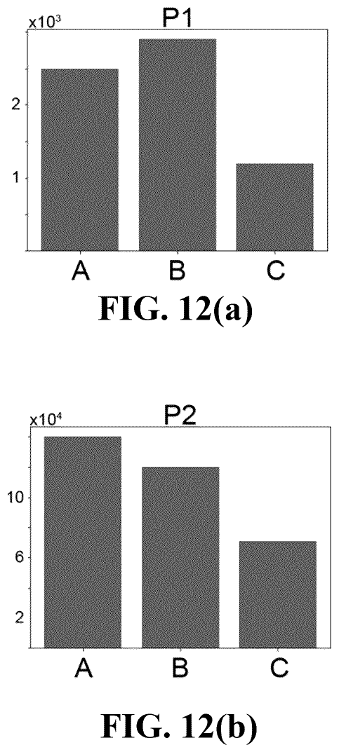

Specimens of type C were printed with a cosine of the hatch progression angle restricted between −1 and 0, to depress the hypothesized spatter induced porosity generating mechanism. The total porosity count was decreased by 52% for P1 and by 49% for P2, as illustrated in FIGS. 12(a) and 12(b), respectively. The null hypothesis comparing the porosity and bulk populations was accepted for metrics of the P1-C specimen, indicating that the porosity generating mechanism is not statistically correlated with the metrics considered. Taken together with the lower energy density of the P2 processing parameters, this combination of the rejection of the null hypothesis are in part due to the sensitivity of these process conditions to spatter.

In brief, qualifying components for aerospace applications requires a thorough understanding of the process-structure-properties relationships. Porosity defects are known to have a strong adverse effect on the mechanical properties of a component. Porosity defects created by lack of fusion have high aspect ratio morphologies leading to stress concentrations that become crack initiation sites. In accordance with the present disclosure, the occurrence of spatter induced porosity can be controlled using the hatch progression angle (relative to crossflow) and can be quantified for predictive purposes using a pyriform density function process metric as part of a method of generating process metrics from at least one point field in accordance with various embodiments of the present disclosure, as described in FIG. 3.

While aspects of the present disclosure has been described in conjunction with specific exemplary implementations, it is evident to those skilled in the art that many alternatives, modifications, and variations will be apparent in light of the foregoing description. Accordingly, the present disclosure is not limited to the precise construction and compositions disclosed herein; any and all modifications, changes, and variations apparent from the foregoing descriptions are within the spirit and scope of the disclosure as defined in the appended claims.

What is claimed is:

1. A method of generating a model for additive manufacturing, comprising:
obtaining a build file containing instructions to additively manufacture a component;
generating at least one point field;
computing a spatter exposure metric from the at least one point field to quantify a risk of spatter induced porosity throughout a build, wherein computing the spatter exposure metric includes:
selecting at least one principal point from the at least one point field;
determining at least one neighborhood using an additive manufacturing model search algorithm for the at least one principal point; and
integrating a pyriform kernel function for the at least one principal point and the at least one neighborhood to obtain the spatter exposure metric; and
updating the at least one point field with the spatter exposure metric computed.

2. The method of claim 1, further comprising determining if the build should be modified based on the spatter exposure metric.

3. The method of claim 2, further comprising modifying the build for the component based on the spatter exposure metric if it is determined that the build should be modified.

4. The method of claim 1, wherein integrating at least one additive manufacturing model kernel function for the at least one principal point is based on a single point in time for the at least one principal point.

5. The method of claim 1, wherein generating the at least one point field for the component includes generating a model-based point field from the build file or generating at least one measure-based point field from in-situ measured data.

6. The method of claim 1, wherein integrating the pyriform kernel function comprises fitting a pyriform shape to spatter conditions of a specific build material, crossflow characteristics, or processing parameters.

7. The method of claim 1, further comprising controlling an occurrence of spatter induced porosity in the build using the computed spatter exposure metric.

8. The method of claim 1, further comprising designing a build strategy to minimize spatter based on the computed spatter exposure metric which includes a modification of the build plane to be below a set focal plane by a distance that is characteristic of the spatter size.

9. The method of claim 8, further comprising printing a component using the designed build strategy.

10. A method of additive manufacturing, comprising:
setting a build's coordinate reference axis to be that of a crossflow reference axis, where the crossflow axis is colinear with the y-axis of the build coordinates;
designing a build file that mitigates spatter induced porosity by enforcing a hatch progression angle during the build with a trigonometric function that is based on the build's coordinate reference axis and the crossflow reference axis; and
printing a component using the designed build file.

11. The method of claim 10, wherein the trigonometric function comprises a cosine function.

12. The method of claim 11, wherein a value of the cosine function of the hatch progression angle is enforced to be between −1 and 0, where the crossflow axis is colinear with a y-axis of the build coordinates and the hatch progression proceeds predominantly opposite the crossflow direction.

13. A non-transitory computer-readable storage medium embodying programmed instructions which, when executed by a processor, are operable for performing operations comprising:
obtaining a build file containing instructions to additively manufacture a component;
generating at least one point field;
computing a spatter exposure metric from the at least one point field to quantify a risk of spatter induced porosity throughout a build, wherein computing the spatter exposure metric includes:
selecting at least one principal point from the at least one point field;
determining at least one neighborhood using an additive manufacturing model search algorithm for the at least one principal point; and
integrating a pyriform kernel function for the at least one principal point and the at least one neighborhood to obtain the spatter exposure metric; and
updating the at least one point field with the spatter exposure metric computed.

14. The non-transitory computer-readable storage medium of claim 13, wherein the operations further comprises determining if the build file should be modified based on the spatter exposure metric.

15. The non-transitory computer-readable storage medium of claim 14, wherein the operations further comprise modifying the build file for the component based on the spatter exposure metric if it is determined that the build file should be modified.

16. The non-transitory computer-readable storage medium of claim 13, wherein integrating the pyriform kernel function comprises fitting a pyriform shape to spatter conditions of a specific build material, crossflow characteristics, or processing parameters.

17. The non-transitory computer-readable storage medium of claim 13, wherein the operations further comprise controlling an occurrence of spatter induced porosity in the build using the computed spatter exposure metric.

18. The non-transitory computer-readable storage medium of claim 13, wherein the operations further comprise designing a build strategy to minimize spatter based on the computed spatter exposure metric which includes a modification of the build plane to be below a set focal plane by a distance that is characteristic of the spatter size.

19. The non-transitory computer-readable storage medium of claim 18, wherein the operations further comprise printing a component using the designed build strategy.

20. The non-transitory computer-readable storage medium of claim 13, wherein generating the at least one point field for the component includes generating a model-based point field from the build file or generating at least one measure-based point field from in-situ measured data.
